(19) United States
(12) Patent Application Publication
(10) Pub. No.: US 2022/0200743 A1
(43) Pub. Date: Jun. 23, 2022

(54) USER TERMINAL AND RADIO COMMUNICATION METHOD

(71) Applicant: NTT DOCOMO, INC., Tokyo (JP)

(72) Inventors: Shohei Yoshioka, Tokyo (JP); Satoshi Nagata, Tokyo (JP); Xiaohong Zhang, Beijing (CN); Shaozhen Guo, Beijing (CN); Xiaolin Hou, Beijing (CN)

(73) Assignee: NTT DOCOMO, INC., Tokyo (JP)

(21) Appl. No.: 17/595,362

(22) PCT Filed: May 14, 2020
(86) PCT No.: PCT/JP2020/019332

§ 371 Date: Nov. 15, 2021

(30) Foreign Application Priority Data
May 16, 2019 (JP) 2019-093131

(51) Int. Cl. H04L 1/18

(52) U.S. Cl. CPC H04L 1/1854; H04L 1/1887; H04L 1/1812

(57) ABSTRACT

At least one of determination or feedback of a HARQ-ACK codebook is appropriately controlled. A user terminal according to one aspect of the present disclosure includes: a control section that determines, in a case where different subcarrier spacings are configured for an uplink and a downlink, on the basis of a hybrid automatic repeat request-acknowledgement (HARQ-ACK) timing value indicated by the number of first time units shorter than a slot for the uplink, a set of one or more candidate opportunities for receiving a downlink shared channel within a given number of the first time units; and a transmitting section that transmits a codebook determined on the basis of the set of the candidate opportunities.

### TECHNICAL FIELD

The present disclosure relates to a user terminal and a radio communication method in a next-generation mobile communication system.

### BACKGROUND ART

In a universal mobile telecommunications system (UMTS) network, specifications of long term evolution (LTE) have been drafted for the purpose of further increasing a data rate, providing low latency, and the like (see Non Patent Literature 1). Further, specifications of LTE-Advanced (third generation partnership project (3GPP) Release. (Rel.) 10 to 14) have been drafted for the purpose of further increasing capacity and advancement of LTE (3GPP Rel. 8 and 9).

Successor systems to LTE (for example, also referred to as 5th generation mobile communication system (5G), 5G+(plus), New Radio (NR), or 3GPP Rel. 15 or later) are also being studied.

In existing LTE systems (for example, 3GPP Rel. 8 to 14), a user terminal (user equipment (UE)) uses at least one of a UL data channel (for example, physical uplink shared channel (PUSCH)) or a UL control channel (for example, physical uplink control channel (PUCCH)) to transmit uplink control information (UCI).

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### SUMMARY OF INVENTION

### Technical Problem

In a future radio communication system (hereinafter, referred to as NR), it is assumed that a value (also referred to as a hybrid automatic repeat request-acknowledgement (HARQ-ACK) timing value or the like) indicating a transmission timing of delivery confirmation information (also referred to as HARQ-ACK, acknowledgement/non-acknowledgement (ACK/NACK), A/N, or the like) for a DL signal (for example, PDSCH) is specified for a user terminal (user equipment (UE)) by using at least one of a higher layer parameter or downlink control information (DCI).

Further, in the NR, it has been studied that the UE determines a codebook including a given HARQ-ACK bit (also referred to as a HARQ-ACK codebook, a HARQ codebook, or the like) on the basis of the HARQ-ACK timing value, and feeds back the codebook to a base station. Thus, it is desirable that the UE can appropriately control at least one of determination or feedback of the codebook.

Thus, an object of the present disclosure is to provide a user terminal and a radio communication method capable of appropriately controlling at least one of determination or feedback of a HARQ-ACK codebook.

### Solution to Problem

A user terminal according to one aspect of the present disclosure includes: a control section that determines, in a case where different subcarrier spacings are configured for an uplink and a downlink, on the basis of a hybrid automatic repeat request-acknowledgement (HARQ-ACK) timing value indicated by the number of first time units shorter than a slot for the uplink, a set of one or more candidate opportunities for receiving a downlink shared channel within a given number of the first time units; and a transmitting section that transmits a codebook determined on the basis of the set of the candidate opportunities.

### Advantageous Effects of Invention

According to one aspect of the present disclosure, at least one of determination or feedback of the HARQ-ACK codebook can be appropriately controlled.

### BRIEF DESCRIPTION OF DRAWINGS

FIG. 1 is a diagram illustrating an example of determination of a HARQ-ACK window according to Case 2.

FIG. 2 is a diagram illustrating an example of a PDSCH time domain RA table.

FIG. 3 is a diagram illustrating an example of determination of a semi-static HARQ-ACK codebook according to Case 2.

FIG. 4 is a diagram illustrating an example of determination of a semi-static HARQ-ACK codebook according to Case 2.

FIGS. 5A and 5B are diagrams illustrating an example of determination of a semi-static HARQ-ACK codebook according to Case 2.

FIG. 6 is a diagram illustrating an example of determination of a HARQ-ACK window according to Case 3.

FIGS. 7A and 7B are diagrams illustrating an example of determination of a semi-static HARQ-ACK codebook according to Case 3.

FIGS. 8A and 8B are diagrams illustrating an example of a sub-slot.

FIG. 9 is a diagram illustrating an example of determination of a HARQ-ACK window according to Case 2 of a first aspect.

FIGS. 10A to 10C are diagrams 10 illustrating an example of a PDSCH time domain RA table according to the first aspect.

FIG. 11 is a diagram illustrating an example of determination of a semi-static HARQ-ACK codebook according to Case 2 of the first aspect.

FIG. 12 is a diagram illustrating an example of determination of a semi-static HARQ-ACK codebook according to Case 2 of the first aspect.

FIG. 13 is a diagram illustrating an example of determination of a HARQ-ACK window according to Case 3 of the first aspect.

FIG. 14 is a diagram illustrating an example of determination of a semi-static HARQ-ACK codebook according to Case 3 of the first aspect.

FIG. 15 is a diagram illustrating an example of determination of a semi-static HARQ-ACK codebook according to Case 3 of the first aspect.

FIGS. 16A and 16B are diagrams illustrating an example of a reference point of a HARQ-ACK timing value K₁ according to the second aspect.

FIG. 17 is a diagram illustrating an example of determination of a HARQ-ACK window according to Case 2 of a second aspect.

FIG. 18 is a diagram illustrating an example of determination of a semi-static HARQ-ACK codebook according to Case 2 of the second aspect.

FIG. 19 is a diagram illustrating an example of determination of a HARQ-ACK window according to Case 3 of the second aspect.

FIGS. 20A to 20E are diagrams illustrating an example of a PDSCH time domain RA table according to the second aspect.

FIGS. 21A and 21B are diagrams illustrating an example of determination of a semi-static HARQ-ACK codebook according to Case 3 described above according to the second aspect.

FIG. 22 is a diagram illustrating an example of a schematic configuration of a radio communication system according to one embodiment.

FIG. 23 is a diagram illustrating an example of a configuration of a base station according to one embodiment.

FIG. 24 is a diagram illustrating an example of a configuration of a user terminal according to one embodiment.

FIG. 25 is a diagram illustrating an example of a hardware configuration of the base station and the user terminal according to one embodiment.

### DESCRIPTION OF EMBODIMENTS

(HARQ-ACK feedback) In the NR, a mechanism has been studied in which a user terminal (user equipment (UE)) performs feedback (also referred to as report, transmission, or the like) of delivery confirmation information (also referred to as hybrid automatic repeat request-acknowledgement (HARQ-ACK), ACKnowledgement/Non-ACK (ACK/NACK), HARQ-ACK information, A/N, or the like) for a downlink shared channel (also referred to as physical downlink shared channel (PDSCH) or the like).

For example, in the NR, a value of a given field in DCI (for example, DCI format 1_0 or 1_1) used for PDSCH scheduling indicates a feedback timing of HARQ-ACK for the PDSCH. In a case where the UE transmits, in a slot #n+k, the HARQ-ACK for the PDSCH received in a slot #n, the value of the given field may be mapped to a value of k. The given field is referred to, for example, a PDSCH-HARQ feedback timing indicator (PDSCH-to-HARQ feedback timing indicator) field or the like.

In the NR, a PUCCH resource used for feedback of HARQ-ACK for the PDSCH is determined on the basis of the value of the given field in the DCI (for example, DCI format 1_0 or 1_1) used for the PDSCH scheduling. The given field may be referred to as, for example, a PUCCH resource indicator (PRI) field, an ACK/NACK resource indicator (ARI) field, or the like. The value of the given field may be referred to as a PRI, an ARI, or the like.

The PUCCH resource mapped to each value of the given field may be configured in the UE in advance by a higher layer parameter. The higher layer parameter may be, for example, “ResourceList” in “PUCCH-ResourceSet” of an information element (IE) of Radio Resource Control (RRC). Note that the RRC IE may be referred to as an RRC parameter or the like. Further, the PUCCH resource may be configured in the UE for each set (PUCCH resource set) including one or more PUCCH resources.

Further, in the NR, it has been studied that the UE is enabled to transmit one or a plurality of physical uplink control channel (PUCCH) for HARQ-ACK within a single slot.

Further, in the NR, one or more HARQ-ACKs may be mapped to a HARQ-ACK codebook, and the HARQ-ACK codebook may be transmitted on a PUCCH resource indicated by given DCI (for example, most recent (last) DCI).

Here, the HARQ-ACK codebook may include a bit for HARQ-ACK in at least one unit of a time domain (for example, a slot), a frequency domain (for example, a component carrier (CC)), a spatial domain (for example, a layer), a transport block (TB), or a group (code block group (CBG)) of code blocks configuring the TB. Note that the CC is also referred to as a cell, a serving cell, a carrier, or the like. Further, the bit is also referred to as a HARQ-ACK bit, HARQ-ACK information, a HARQ-ACK information bit, or the like.

The HARQ-ACK codebook is also referred to as a PDSCH-HARQ-ACK codebook (pdsch-HARQ-ACK-Codebook), a codebook, a HARQ codebook, a HARQ-ACK size, or the like.

The number (size) of bits or the like included in the HARQ-ACK codebook may be determined in a semi-static or dynamic manner. The HARQ-ACK codebook of which the size is determined in a semi-static manner is also referred to as a semi-static HARQ-ACK codebook, a type-1 HARQ-ACK codebook, a semi-static codebook, or the like. The HARQ-ACK codebook of which the size is determined in a dynamic manner is also referred to as a dynamic HARQ-ACK codebook, a type-2 HARQ-ACK codebook, a dynamic codebook, or the like.

Whether to use the semi-static HARQ-ACK codebook or the dynamic HARQ-ACK codebook may be configured in the UE by a higher layer parameter (for example, pdsch-HARQ-ACK-Codebook).

In the case of the semi-static HARQ-ACK codebook, the UE may feed back, in a given range, a HARQ-ACK bit corresponding to the given range regardless of presence or absence of PDSCH scheduling. The given range is also referred to as a HARQ-ACK window, a HARQ-ACK bundling window, a HARQ-ACK feedback window, a bundling window, a feedback window, or the like.

The semi-static HARQ-ACK codebook may be determined on the basis of at least one parameter of the following a) to d):

a) a value (HARQ-ACK timing value) K₁ indicating a timing of HARQ-ACK;

b) a table (PDSCH time domain resource allocation (RA) table) used for determination of a time domain resource allocated to the PDSCH;

c) a ratio between a configuration μ_{DL} of a downlink (or downlink BWP) subcarrier spacing and a configuration μ_{UL} of an uplink (or uplink BWP) subcarrier spacing, 2 to the (μ_{DL}−μ_{UL})-th power, in a case where different subcarrier spacings are configured for the downlink and the uplink; or

d) a cell-specific TDD UL/DL configuration (for example, TDD-UL-DL-ConfigurationCommon), and a slot-specific configuration (for example, TDD-UL-DL-ConfigDedicated) overwriting the cell-specific TDD UL/DL configuration.

Specifically, the UE may determine a set of candidate PDSCH reception opportunities M_{A, c} capable of transmitting a HARQ-ACK bit in a PUCCH transmitted in the slot #n in a serving cell c (or an active downlink BWP and an uplink BWP of the serving cell c) on the basis of the at least one parameter.

(Numerology)

Meanwhile, in the NR, it is also assumed that the UE uses different numerologies for the downlink and the uplink. Here, a numerology may include, for example, at least one of a subcarrier spacing (SCS), a symbol length, a length of a cyclic prefix (CP), or the like.

Note that the subcarrier spacing and the symbol length may have a relationship in which they are reciprocal to each other. For example, when the subcarrier spacing becomes n (an integer of n>0) times, the symbol length may become 1/n times. Further, when the subcarrier spacing becomes n times, a slot (length of the slot) including 14 symbols may become 1/n times, and when the subcarrier spacing becomes 1/n times, the length of the slot may become n times.

Specifically, it has been studied that at least one of the downlink (or downlink BWP) subcarrier spacing or the uplink (or uplink BWP) subcarrier spacing is configured in the UE by a higher layer parameter. The higher layer parameter may be, for example, “subcarrier Spacing” in “BWP” in “BWP-Downlink” or “BWP-Uplink” of the RRC IE.

For example, the higher layer parameter described above (for example, p in the following table) may be associated with information (for example, a normal CP or an extended CP) indicating a downlink (or downlink BWP) or uplink (or uplink BWP) subcarrier spacing Δf and a cyclic prefix (CP) (or CP length).

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

As described above, in the NR, for example, Cases 1 to 3 below is assumed for uplink and downlink numerologies.

Case 1: The same numerology (for example, the subcarrier spacing, the symbol length, and the CP length) is configured for the downlink and the uplink.

Case 2: Different numerologies are configured for the downlink and the uplink, and the uplink subcarrier spacing (or p described above) is less than the downlink subcarrier spacing (or p described above).

Case 3: Different numerologies are configured for the downlink and the uplink, and the uplink subcarrier spacing (or μ described above) is greater than the downlink subcarrier spacing (or μ described above).

As in Cases 2 and 3 described above, in a case where the downlink and uplink numerologies are different from each other, the UE can generate a semi-static HARQ-ACK codebook on the basis of the at least one parameter of the a) to d) described above, as follows. Specifically, the UE may determine, in accordance with Steps 1) and 2) below, a set of candidate PDSCH reception opportunities M_{A, c} capable of transmitting a HARQ-ACK bit in the slot #n, and generate the semi-static HARQ-ACK codebook on the basis of a reception opportunity M_{A, c} in the set.

Step 1)

The UE determines the HARQ-ACK window on the basis of a set of HARQ-ACK timing values K₁. Note that the set may be referred to as cardinality of the HARQ-ACK timing values K₁, and may be expressed as C(K₁). The UE may determine C(K₁) on the basis of at least one of a given field value in DCI or a higher layer parameter (for example, dl-DataToUL-ACK).

Step 2)

The UE may determine a candidate PDSCH reception opportunity M_{A, c} in each slot for each HARQ-ACK timing value K₁ in C(K₁). The UE may repeat Steps 2-1) and 2-2) for each HARQ-ACK timing value K₁ in C(K₁) to determine a semi-static HARQ-ACK codebook to be transmitted in the slot #n.

Step 2-1)

On the basis of at least one of the PDSCH time domain RA table or a format of one or more slots corresponding to the HARQ-ACK timing value K₁, the UE may determine a candidate PDSCH reception opportunity M_{A, c} available in the slots. The candidate PDSCH reception opportunity may be one or more candidate periods (also referred to as opportunities, candidate opportunities, or the like) for PDSCH reception.

Specifically, the UE may determine the candidate PDSCH reception opportunities M_{A, c} for the slots described above on the basis of the PDSCH time domain RA table, and then exclude at least some of the candidate PDSCH reception opportunities M_{A, c} as unavailable on the basis of the format of the slots (alternatively, at least some of the candidate PDSCH reception opportunities M_{A, c} may be extracted as available on the basis of the format of the slots described above).

The format of each slot may be determined on the basis of at least one of the cell-specific TDD UL/DL configuration (for example, the TDD-UL-DL-ConfigurationCommon), a slot individual TDD UL/DL configuration (for example, TDD-UL-DL-ConfigDedicated), or DCI.

Step 2-2)

The UE gives an index to the candidate PDSCH reception opportunity M_{A, c} determined in step 2-1). The UE may give the same index (value) to a plurality of candidate PDSCH reception opportunities M_{A, c} in which at least some symbols overlap, and generate a HARQ-ACK bit for each index (value) of the candidate PDSCH reception opportunity.

<Case 2>

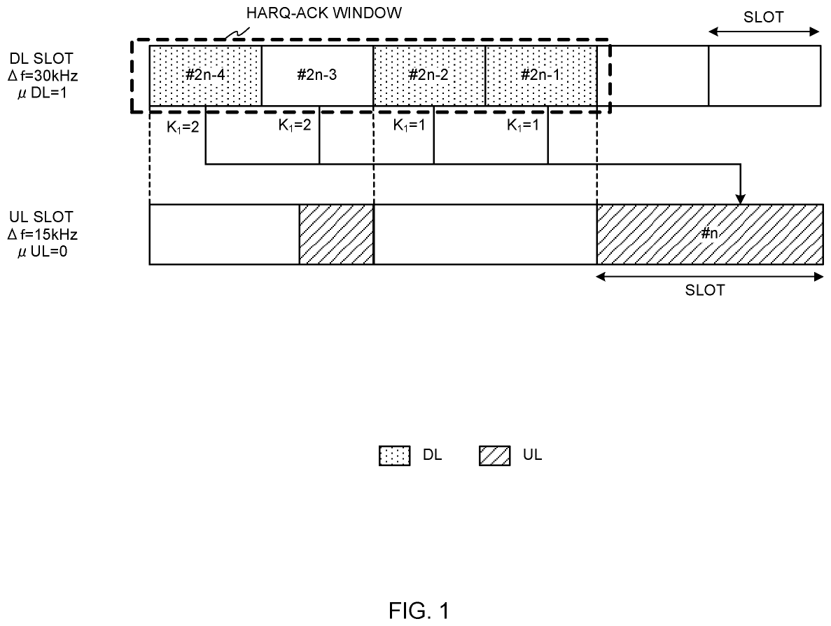

With reference to FIGS. 1 to 4, 5A, and 5B, an example will be exemplified of determination of a semi-static HARQ-ACK codebook in Case 2 described above using Steps 1) and 2) described above. FIG. 1 is a diagram illustrating an example of determination of a HARQ-ACK window according to Case 2 described above using Step 1).

For example, FIG. 1 illustrates an example in which a subcarrier spacing 30 kHz is configured in a DL and a subcarrier spacing 15 kHz is configured in a UL. Note that in the present disclosure, a DL slot is a slot to which a numerology for the DL is applied, and may or may not include a DL symbol. Similarly, a UL slot is a slot to which a numerology for the UL is applied, and may or may not include a UL symbol.

As illustrated in FIG. 1, in Case 2, one HARQ-ACK timing value K₁ may be associated with a plurality of DL slots. The number of DL slots associated with one HARQ-ACK timing value K₁ may be indicated by 2\hat{ }(μ_{DL}−μ_{UL}) (2 to the (μ_{DL}−μ_{UL})-th power). Here, μ_{DL} and μ_{UL} are indexes (for example, p in Table 1 described above) indicating the DL and UL numerologies, respectively, and may be associated with the subcarrier spacings.

For example, in FIG. 1, a set of HARQ-ACK timing values K₁ includes 2 and 1. For example, in FIG. 1, C(K₁)={2,1}. In FIG. 1, since μ_{DL}=1 and μ_{UL}=0, the number of DL slots associated with each HARQ-ACK timing value K₁ in the set is 2 (=2₍₁₋₀₎). For this reason, the HARQ-ACK window for a HARQ-ACK bit transmitted in the UL slot #n includes DL slots #2n−4, #2n−3, #2n−2, and #2n−1.

As described above, in Step 1) of Case 2, the UE may determine the size of the HARQ-ACK window (or DL slots or the number thereof in the HARQ-ACK window) on the basis of at least one of the number of HARQ-ACK timing values K₁ in the set described above or the number 2\hat{ }(μ_{DL}−μ_{UL}) of DL slots associated with each HARQ-ACK timing value K₁.

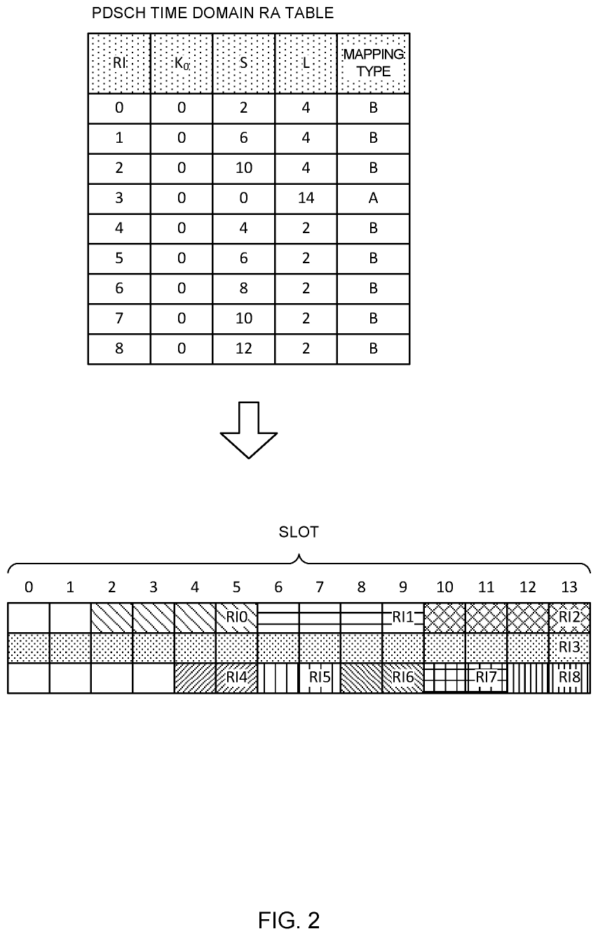

FIG. 2 is a diagram illustrating an example of the PDSCH time domain RA table. As illustrated in FIG. 2, in the PDSCH time domain RA table, for example, a row index (RI) may be associated with at least one of an offset K₀, an index S of a start symbol to which a PDSCH is allocated, the number of symbols (allocation length) L allocated to the PDSCH, or a mapping type of the PDSCH.

Each row of the PDSCH time domain RA table may indicate a PDSCH time domain RA (that is, a candidate PDSCH reception opportunity) for the PDSCH. Further, a parameter (for example, at least one of K, S, L, or a mapping type) of each row may be configured in the UE by a higher layer parameter (for example, “PDSCH-TimeDomainResourceAllocationList”of the RRC IE). Note that S and L may be derived on the basis of a given identifier (for example, it is also referred to as “startSymbolAndLength” of the RRC IE, start and length indicator (SLIV), or the like), and the higher layer parameter described above may include the SLIV.

As illustrated in FIG. 2, each row of the PDSCH time domain RA table may be associated with a candidate PDSCH reception opportunity M_{A, c}. For example, in the PDSCH time domain RA table of FIG. 2, in a case of RI=0, since K₀=0, S=2, and L=4, a candidate PDSCH reception opportunity (RI0) including four symbols from symbol #2 (that is, symbols #2 to #5) of a given slot may be associated with RI=0. Similarly, in FIG. 2, candidate PDSCH reception opportunities (RI1 to RI8) are illustrated that are each associated with RI=1 to 8.

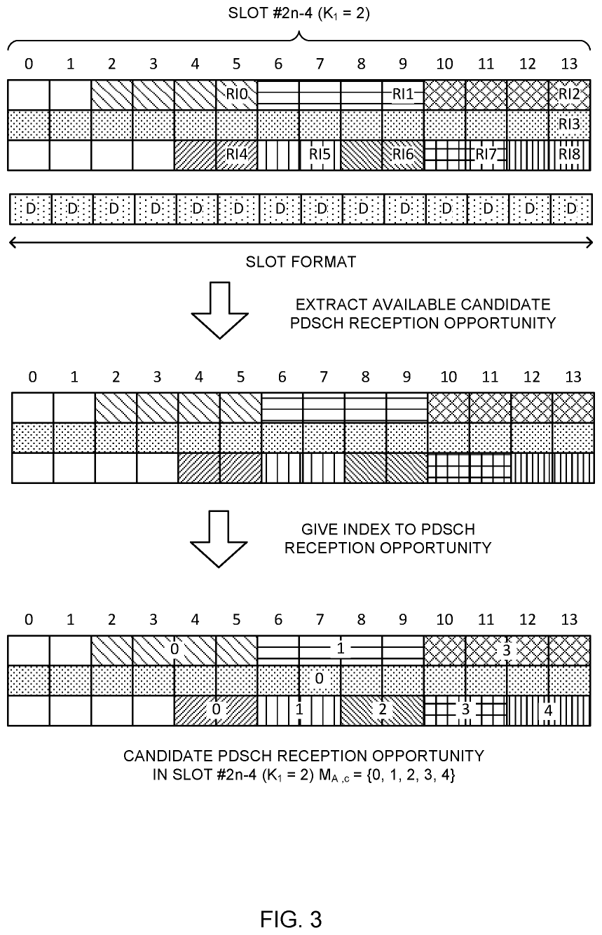

FIGS. 3, 4, 5A, and 5B are diagrams illustrating an example of determination of a semi-static HARQ-ACK codebook according to Case 2 described above using Step 2 described above. Note that in FIGS. 3, 4, 5A, and 5B, it is assumed that the PDSCH time domain RA table illustrated in FIG. 2 is used, but the PDSCH time domain RA table is not limited to that illustrated in FIG. 2.

FIG. 3 illustrates a candidate PDSCH reception opportunity determined by Step 2) described above in the DL slot #2n−4 of FIG. 1. As illustrated in FIG. 3, the DL slot #2n−4 has a format including only downlink symbols (D). For this reason, in the DL slot #2n−4, all candidate PDSCH reception opportunities M_{A, c} determined on the basis of each of RI=0 to 8 are available.

Thus, as illustrated in FIG. 3, all candidate PDSCH reception opportunities M_{A, c} determined on the basis of RI=0 to 8 are extracted, and indexes (identifiers or IDs) are given to the extracted candidate PDSCH reception opportunities M_{A, c}. Here, the same index may be given to a plurality of candidate PDSCH reception opportunities M_{A, c} in which at least some symbols overlap (collide).

For example, in FIG. 3, since some symbols of three candidate PDSCH reception opportunities M_{A, c} determined on the basis of RI=0, 3, and 4 overlap, the same index “0” is given to these candidate PDSCH reception opportunities M_{A, c.} Similarly, since some symbols of two candidate PDSCH reception opportunities M_{A, c} determined on the basis of RI=2 and 7 overlap, the same index “3” is given to these candidate PDSCH reception opportunities M_{A, c}.

The candidate PDSCH reception opportunities M_{A, c} in the DL slot #2n−4 include candidate PDSCH reception opportunities identified by different indexes (values) “0” to “4”.

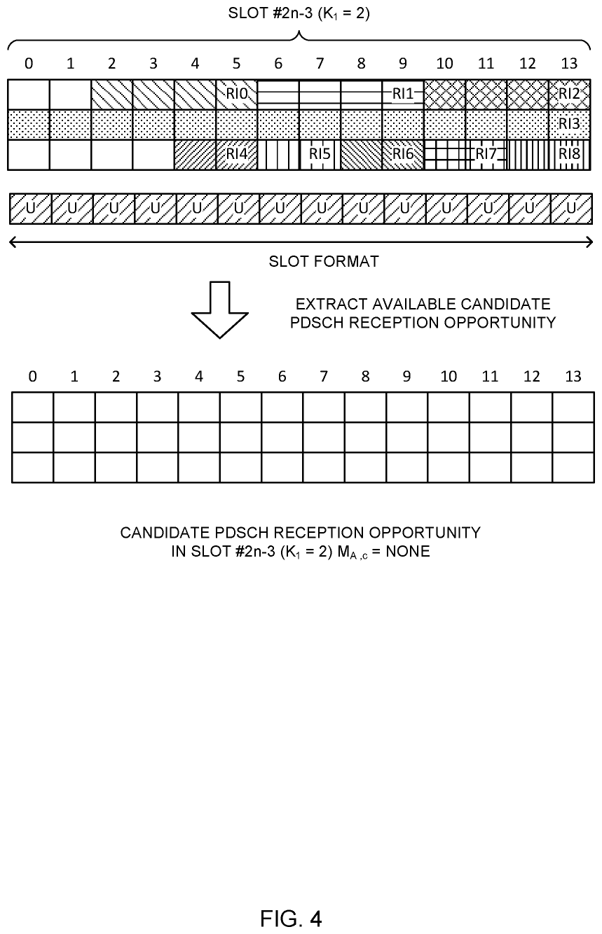

FIG. 4 illustrates a candidate PDSCH reception opportunity determined by Step 2) described above in the DL slot #2n−3 of FIG. 1. As illustrated in FIG. 4, the DL slot #2n−3 has a format including only uplink symbols (U).

Thus, as illustrated in FIG. 4, candidate PDSCH reception opportunities available in DL slot #2n−3 are not extracted. In this case, a HARQ-ACK bit corresponding to the DL slot #2n−3 does not have to be included in a semi-static HARQ-ACK codebook corresponding to the HARQ-ACK window in FIG. 1.

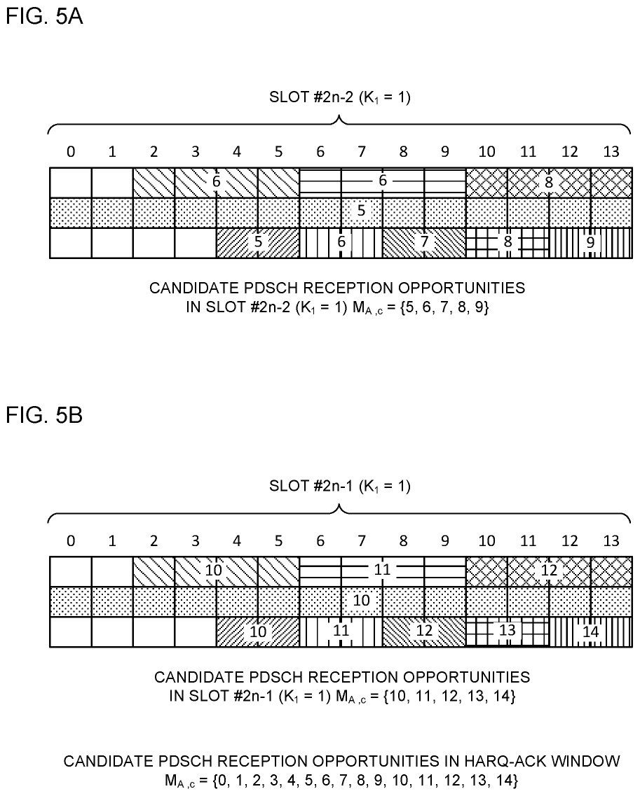

FIG. 5A illustrates a candidate PDSCH reception opportunity determined by Step 2) described above in the DL slot #2n−2 of FIG. 1. Since the DL slot #2n−2 is a format including only downlink symbols (D), all candidate PDSCH reception opportunities M_{A, c} determined on the basis of each of RI=0 to 8 are available in the DL slot #2n−2.

As described in FIG. 3, the candidate PDSCH reception opportunities with the indexes “0” to “4” are determined in the DL slot #2n−4 in the HARQ-ACK window in FIG. 1. For this reason, in FIG. 5A, indexes “5” to “9” subsequent to those in the DL slot #2n−4 may be given to the candidate PDSCH reception opportunity available in the DL slot #2n−2 in accordance with a rule similar to that in FIG. 3.

Similarly, FIG. 5B illustrates a candidate PDSCH reception opportunity determined by Step 2) described above in the DL slot #2n−1 of FIG. 1. Similarly to FIG. 5A, since the DL slot #2n−1 is a format including only downlink symbols (D), all candidate PDSCH reception opportunities M_{A, c} determined on the basis of each of RI=0 to 8 are available. Thus, indexes “10” to “14” subsequent to those in the DL slot #2n−2 may be given to the candidate PDSCH reception opportunity available in the DL slot #2n−1 in accordance with a rule similar to that in FIG. 3.

As described above, the candidate PDSCH reception opportunities M_{A, c} in the HARQ-ACK window of FIG. 1 may include the candidate PDSCH reception opportunities with the indexes “0” to “4” in the DL slot #2n−4 of FIG. 3, the candidate PDSCH reception opportunities with the indexes “5” to “9” in the DL slot #2n−2 of FIG. 5A, and the candidate PDSCH reception opportunities with the indexes “10” to “14” in the DL slot #2n−1 of FIG. 5B.

The UE may generate a given number of HARQ-ACK bits for a candidate PDSCH reception opportunity for each index in the HARQ-ACK window. For example, in a case where one transport block (TB) is received in each candidate PDSCH reception opportunity and retransmission control is performed on a TB basis, the size of the semi-static HARQ-ACK codebook may be 15 bits that is equal to the number of candidate PDSCH reception opportunities in the HARQ-ACK window. Note that the TB is also referred to as a codeword (CW) or the like.

As described above, the UE can determine the size of the semi-static HARQ-ACK codebook on the basis of the number of candidate PDSCH reception opportunities to which different indexes are given within the HARQ-ACK window.

<Case 3>

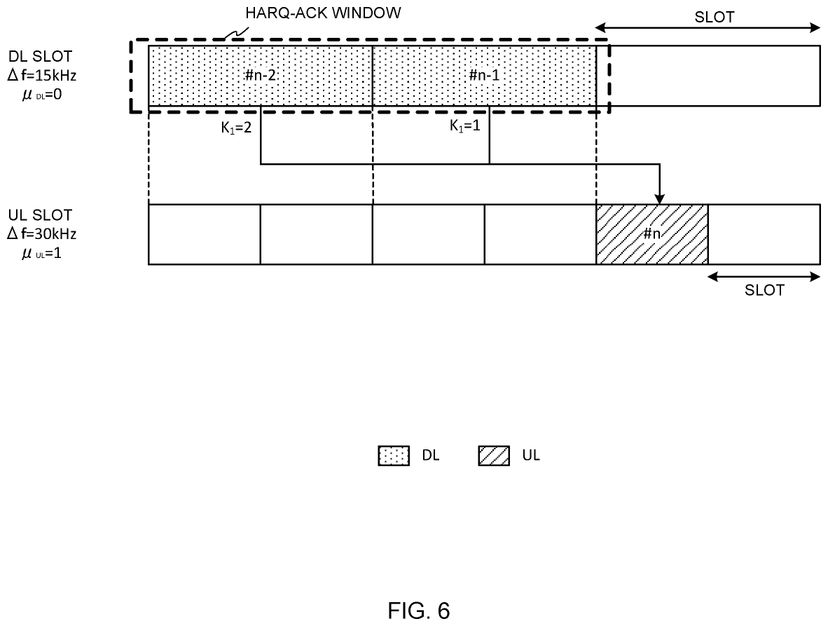

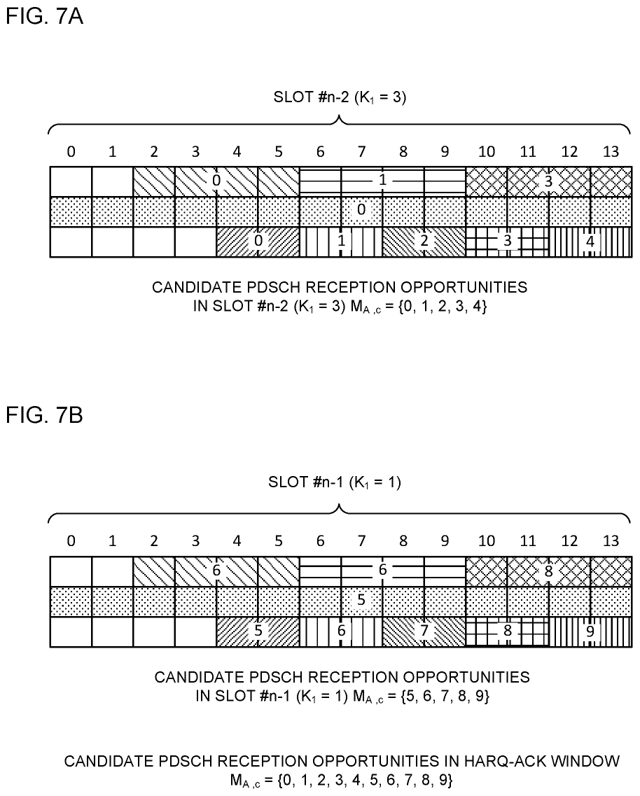

With reference to FIGS. 6, 7A, and 7B, an example will be exemplified of determination of a semi-static HARQ-ACK codebook in Case 3 described above using Steps 1) and 2) described above. FIG. 6 is a diagram illustrating an example of determination of a HARQ-ACK window according to Case 3 using Step 1 described above. In Case 3, differences from Case 2 (FIGS. 1 to 4, 5A, and 5B) will be mainly described, and description of similar points will be omitted.

For example, FIG. 6 illustrates an example in which a subcarrier spacing 15 kHz is configured in the DL and a subcarrier spacing 30 kHz is configured in the UL. For example, in FIG. 6, a set of HARQ-ACK timing values K₁ includes 2 and 1.

As illustrated in FIG. 6, in Case 3, Step 2) may be performed for the HARQ-ACK timing value K₁ satisfying a given condition among the set (C(K₁)) of the HARQ-ACK timing values K₁ determined by at least one of a higher layer parameter or DCI.

The given condition may be, for example, that the HARQ-ACK timing value K₁ satisfies Formula (1) below. Here, n_{U} is an index of a slot in which a semi-static HARQ-ACK codebook is transmitted. Further, K_{l, k} is a given HARQ-ACK timing value K₁ in a set (C(K₁)) of the HARQ-ACK timing values K₁.

mod(n_{U}−K_{l,k}+1,max(2^{μ}^{_{UL}}^{-μ}^{_{DL}},1))=0 (Formula 1)

FIGS. 7A and 7B are diagrams illustrating an example of determination of a semi-static HARQ-ACK codebook according to Case 3 described above using Step 2 described above. Note that, also in FIGS. 7A and 7B, it is assumed that the PDSCH time domain RA table illustrated in FIG. 2 is used as an example. Further, it is assumed that the HARQ-ACK timing values K₁=2 and 1 in FIG. 6 satisfy the given condition described above.

FIG. 7A illustrates a candidate PDSCH reception opportunity determined by Step 2) described above in a DL slot #n−2 of FIG. 6. Since the DL slot #n−2 is a format including only downlink symbols (D), all candidate PDSCH reception opportunities M_{A, c} determined on the basis of each of RI=0 to 8 are available in the DL slot #n−2. For this reason, indexes “0” to “4” may be given to the candidate PDSCH reception opportunities in accordance with the rule described in FIG. 3.

Similarly, FIG. 7B illustrates a candidate PDSCH reception opportunity determined by Step 2) described above in a DL slot #n−1 of FIG. 6. Similarly to FIG. 7A, since the DL slot #n−1 is a format including only downlink symbols (D), all candidate PDSCH reception opportunities M_{A, c} determined on the basis of each of RI=0 to 8 are available. Thus, indexes “5” to “9” subsequent to those in the DL slot #n−2 may be given to the candidate PDSCH reception opportunity available in the DL slot #n−1 in accordance with a rule similar to that in FIG. 3.

As described above, the candidate PDSCH reception opportunities M_{A, c} in the HARQ-ACK window of FIG. 6 may include the candidate PDSCH reception opportunities with the indexes “0” to “4” in the DL slot #n−2 of FIG. 7A, and the candidate PDSCH reception opportunities with the indexes “5” to “9” in the DL slot #n−1 of FIG. 7B. The UE may determine the size of the semi-static HARQ-ACK codebook on the basis of the number of candidate PDSCH reception opportunities (here, 10) to which different indexes are given within the HARQ-ACK window.

Meanwhile, in the NR after Rel. 16, to satisfy requirements of an ultra-reliable and low latency service (for example, a service (URLLC service) related to Ultra Reliable and Low Latency Communications (URLLC)), it has also been studied to support (introduce) a HARQ-ACK timing value K₁ using a time unit shorter (finer) than a slot.

However, in a case where the HARQ-ACK timing value K1 using the time unit shorter than the slot is introduced, how to determine (construct or generate) the semi-static HARQ-ACK codebook becomes a problem. In particular, in a case where different numerologies are applied in the DL and the UL, how to configure the semi-static HARQ-ACK codebook on the basis of the HARQ-ACK timing value K1 using the time unit shorter than the slot becomes a problem.

Thus, the present inventors have studied a method of appropriately configuring the semi-static HARQ-ACK codebook on the basis of the HARQ-ACK timing value K1 using the time unit shorter than the slot in the case where different numerologies are applied in the DL and the UL, and have reached the present invention.

Hereinafter, embodiments according to the present disclosure will be described in detail with reference to the drawings. Hereinafter, a case will be mainly described where different numerologies are applied in the DL and the UL (Case 2 or Case 3 described above); however, the present invention may be applied to a case where numerologies are applied in which at least some features are the same between the DL and the UL (Case 1 described above).

(First Aspect)

In a first aspect, a description will be given of generation of a semi-static HARQ-ACK codebook based on a HARQ-ACK timing value K₁ using the time unit shorter than the slot in a case where different numerologies are applied in the DL and the UL.

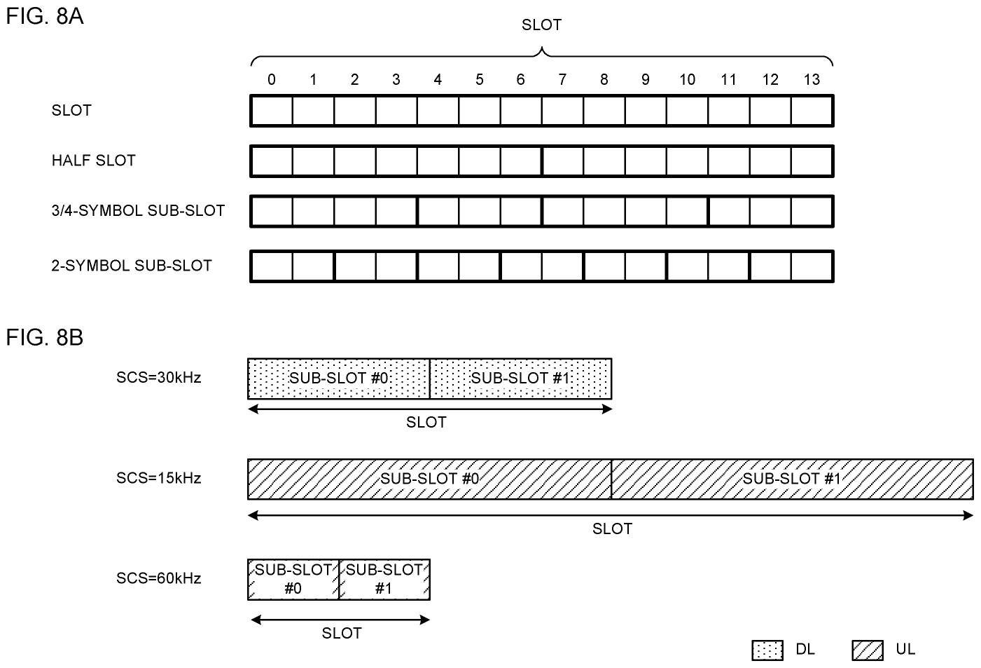

FIG. 8A illustrates an example of the time unit shorter than the slot. As illustrated in FIG. 8A, a half slot may include seven symbols, and two half slots may be included in one slot. Note that the half slot may be paraphrased as a sub-slot of seven symbols.

Further, the sub-slot may include three or four symbols, and four sub-slots may be included in one slot. Alternatively, the sub-slot may include two symbols, and seven sub-slots may be included in one slot. Note that the half slot may be referred to as a sub-slot of seven symbols. Note that the order of a sub-slot of three symbols and a sub-slot of four symbols is not limited to that illustrated in FIG. 8A, and it is sufficient if one slot includes two sub-slots of three symbols and two sub-slots of four symbols.

The UE may determine granularity (for example, any of a slot, a half slot (a sub-slot of seven symbols), a sub-slot of three/four symbols, and a sub-slot of two symbols in FIG. 8A) of the HARQ-ACK timing value K₁ on the basis of at least one of the higher layer parameter or the DCI. Hereinafter, it is assumed that the “sub-slot” collectively refers to a sub-slot (half slot) of seven symbols, a sub-slot of three/four symbols, or a sub-slot of two symbols.

The HARQ-ACK timing value K₁ may be indicated (given) by the number of sub-slots in a UL slot. That is, the HARQ-ACK timing value K₁ may be indicated with a time length of one sub-slot in the UL slot as the granularity (or unit).

In the first aspect, one DL slot may be divided into a plurality of DL sub-slots on the basis of the number of sub-slots (UL sub-slots) in one UL slot. Note that one UL sub-slot may be regarded to correspond to one virtual DL sub-slot. One virtual DL sub-slot has a time length equal to that of one UL sub-slot, and may include one or more DL slots or one or more DL sub-slots.

The number of sub-slots (DL sub-slots) in one DL slot may be determined on the basis of the number of UL sub-slots in a UL slot. For example, the number of the DL sub-slots may be the same as the number of the UL sub-slots.

Here, the DL sub-slot may be defined on the basis of a symbol to which the DL numerology is applied. Further, the UL sub-slot may be defined on the basis of a symbol to which the UL numerology is applied.

FIG. 8B illustrates examples of the sub-slot of seven symbols. As illustrated in FIG. 8B, even if the numbers of symbols in the sub-slot are the same as each other, in a case where the subcarrier spacings are different from each other, time lengths of one sub-slot may be different from each other.

For example, in FIG. 8B, a subcarrier spacing of 30 kHz is applied in the UL, and one UL slot includes two UL sub-slots #0 and #1. In the DL, the UE may assume (determine) the number, two, of DL sub-slots (virtual DL sub-slots) in one DL slot on the basis of the number, two, of UL sub-slots in one UL slot.

On the other hand, in the DL, in a case where the subcarrier spacing of 15 kHz that is a half of the spacing in the UL or 30 kHz that is two times the spacing in the UL is applied, the length of each DL sub-slot is two times or half of the length of the UL sub-slot.

In the first aspect, in a case where the semi-static HARQ-ACK codebook is determined on the basis of the sub-slot level HARQ-ACK timing value K₁, the UE may use at least one parameter of the a) to d) described above. A description will be given of determination of a semi-static HARQ-ACK codebook in a case where different numerologies are applied for the DL and UL.

<Case 2>

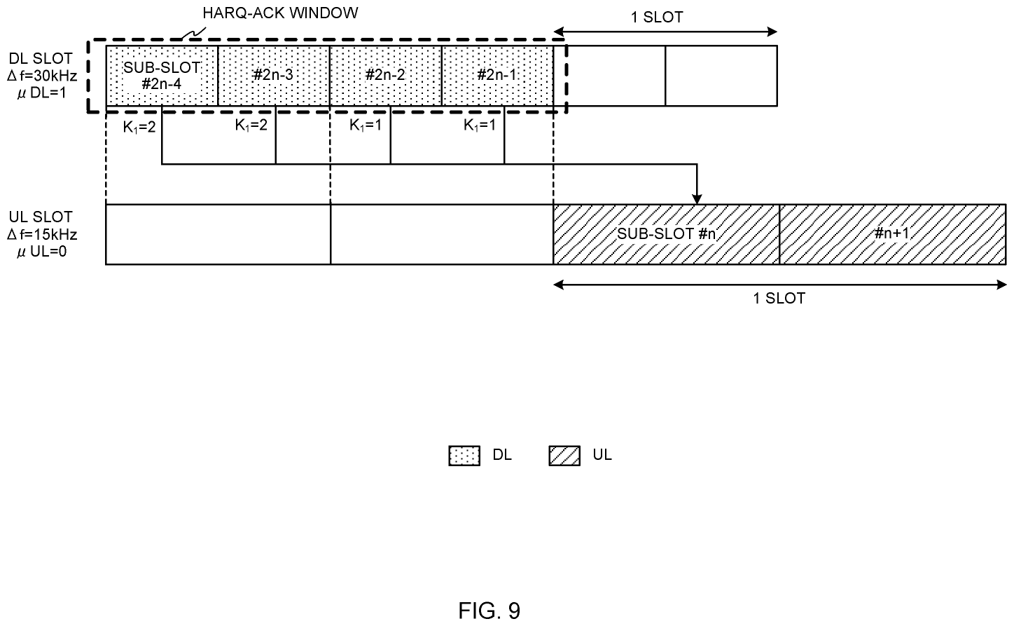

With reference to FIGS. 9 to 12, a description will be given of determination of a set of candidate PDSCH reception opportunities M_{A, c} based on the granularity of the sub-slot level HARQ-ACK timing value K₁ in Case 2 of the first aspect. Hereinafter, a description will be mainly given of differences from Step 1) and 2) using the slot level HARQ-ACK timing value K₁. FIG. 9 is a diagram illustrating an example of determination of a HARQ-ACK window according to Case 2 of the first aspect.

For example, in FIG. 9, a subcarrier spacing 30 kHz is configured in the DL, and a subcarrier spacing 15 kHz is configured in the UL. Further, in FIG. 9, a plurality of UL sub-slots (here, two UL sub-slots #n and #n+1) is included in one UL slot. Further, in FIG. 9, the HARQ-ACK timing value K₁ may be given on the basis of the UL sub-slot (with the UL sub-slot as a unit).

As illustrated in FIG. 9, in Case 2, one HARQ-ACK timing value K₁ may be associated with a plurality of DL sub-slots. As described above, Case 2 of the first aspect is different from Step 1) described above in that one HARQ-ACK timing value K₁ is associated with a plurality of DL sub-slots instead of a plurality of DL slots.

The number of DL sub-slots associated with one HARQ-ACK timing value K₁ may be indicated by 2\hat{ }(μ_{DL}−μ_{UL}) (2 to the (μ_{DL}−μ_{UL})-th power). Here, μ_{DL} and μ_{UL} are indexes (for example, p in Table 1 described above) indicating the DL and UL numerologies, respectively, and may be associated with the subcarrier spacings.

For example, in FIG. 9, a set of HARQ-ACK timing values K₁ includes 2 and 1 (C(K₁)={2, 1}). Further, in FIG. 9, since μ_{DL}=1 and μ_{UL}=0, the number of DL sub-slots associated with each HARQ-ACK timing value K₁ in the set is 2 (=2⁽¹⁻⁰⁾). For this reason, the HARQ-ACK window for a HARQ-ACK bit transmitted in the UL sub-slot #n includes DL sub-slots #2n−4, #2n−3, #2n−2, and #2n−1.

As described above, in Step 1) of Case 2, the UE may determine the size of the HARQ-ACK window (or DL slots or the number thereof in the HARQ-ACK window) on the basis of at least one of the number of HARQ-ACK timing values K₁ in the set described above or the number 2\hat{ }(μ_{DL}−μ_{UL}) of DL sub-slots associated with each HARQ-ACK timing value K₁.

In FIG. 9, one UL sub-slot corresponds to two DL sub-slots (one DL slot). For this reason, the UE may regard the two DL sub-slots (one DL slot) as a virtual DL sub-slot. In this case, it can be said that one HARQ-ACK timing value K₁ is associated with one virtual DL sub-slot.

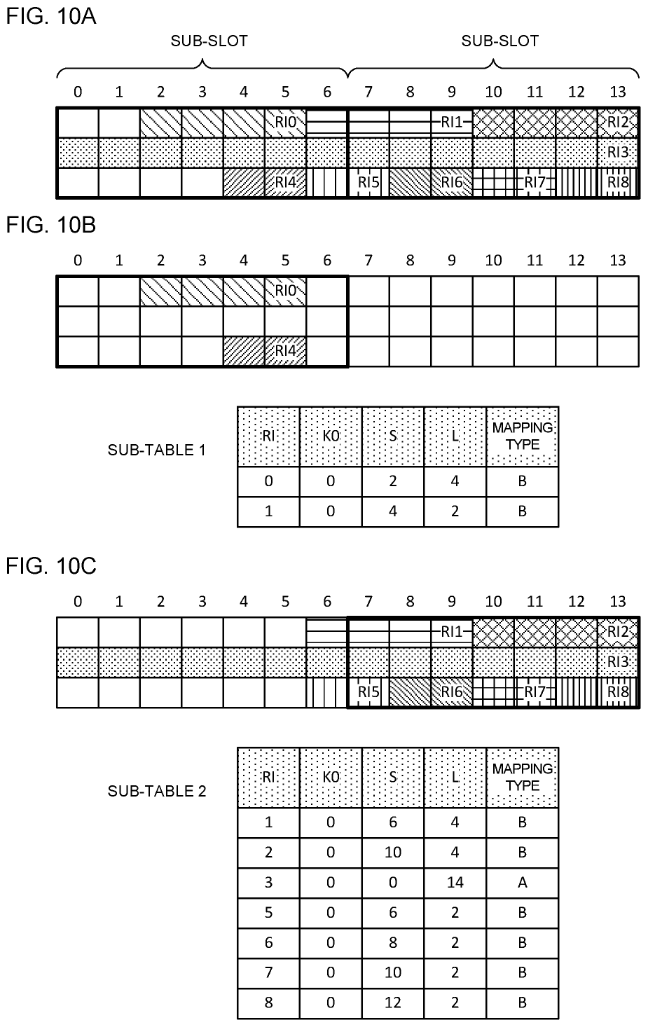

FIGS. 10A to 10C are diagrams illustrating an example of a PDSCH time domain RA table according to the first aspect. As illustrated in FIGS. 10A to 10C, the PDSCH time domain RA table (see, for example, FIG. 2) may be divided into a plurality of sub-tables on the basis of the granularity of the HARQ-ACK timing value K₁. The number of sub-tables may be determined on the basis of at least one of the number of sub-slots in one slot or a ratio between UL and DL subcarrier spacings.

For example, in a case where the granularity of the HARQ-ACK timing value K₁ is a sub-slot of seven symbols (half slot), the PDSCH time domain RA table may be divided into two sub-tables. Further, in a case where the granularity of the HARQ-ACK timing value K₁ is a sub-slot of three or four symbols, the PDSCH time domain RA table may be divided into four sub-tables. Further, in a case where the granularity of the HARQ-ACK timing value K₁ is a sub-slot of two symbols, the PDSCH time domain RA table may be divided into seven sub-tables.

As described above, each sub-slot (DL sub-slot or UL sub-slot) in the DL slot or the UL slot may correspond to each sub-slot of the PDSCH time domain RA table on a one-to-one basis.

Which sub-table (which sub-slot) each row (or the candidate PDSCH reception opportunity indicated by each row) indicated in the PDSCH time domain RA table (for example, FIG. 2) belongs to may be determined on the basis of a given rule. For example, the UE may determine which sub-table each candidate PDSCH reception opportunity belongs to on the basis of at least one of:
a start symbol of the candidate PDSCH reception opportunity;
a last symbol of the candidate PDSCH reception opportunity; or
in a case where the candidate PDSCH reception opportunity spans a plurality of time units (for example, a plurality of half slots or sub-slots) in the slot, which time unit includes more number of symbols in the candidate PDSCH reception period.

Note that, in a case where the start and end symbols of one candidate PDSCH reception opportunity spans a plurality of sub-slots, the candidate PDSCH reception opportunity may belong to the plurality of sub-slots (or a plurality of sub-tables respectively corresponding to the plurality of sub-slots) or may belong to any of the plurality of sub-slots (or the plurality of sub-tables). That is, a row indicating one candidate PDSCH reception opportunity may be included in each of the plurality of sub-tables, or may be included in only one of the sub-tables.

Step 2)

The UE may determine a candidate PDSCH reception opportunity M_{A, c} in each DL sub-slot or each DL slot for each HARQ-ACK timing value K₁ in C(K₁). The UE may repeat Steps 2-1) and 2-2) below for each HARQ-ACK timing value K₁ in C(K₁) to determine a semi-static HARQ-ACK codebook to be transmitted in the UL sub-slot.

Step 2-1)

The UE may determine a candidate PDSCH reception opportunity M_{A, c} available in the DL sub-slot on the basis of at least one of a sub-table obtained by dividing the PDSCH time domain RA table, or a format of a DL sub-slot or each DL slot corresponding to the HARQ-ACK timing value K₁.

Specifically, the UE may exclude at least some of PDSCH reception opportunities M_{A, c} belonging to a sub-table corresponding to the sub-slot as unavailable on the basis of the format of the DL sub-slot or each DL slot (alternatively, may extract at least some of the candidate PDSCH reception opportunities M_{A, c} as available on the basis of the format of the sub-slot).

Note that the format of the DL sub-slot or each DL slot may be determined on the basis of at least one of a cell-specific TDD UL/DL configuration (for example, the TDD-UL-DL-ConfigurationCommon described above), a slot individual TDD UL/DL configuration (for example, TDD-UL-DL-ConfigDedicated), or DCI.

Step 2-2)

The UE gives an index to the candidate PDSCH reception opportunity M_{A, c} determined in step 2-1). The UE may give the same index (value) to a plurality of candidate PDSCH reception opportunities M_{A, c} in which at least some symbols overlap, and generate a HARQ-ACK bit for each index (value) of the candidate PDSCH reception opportunity.

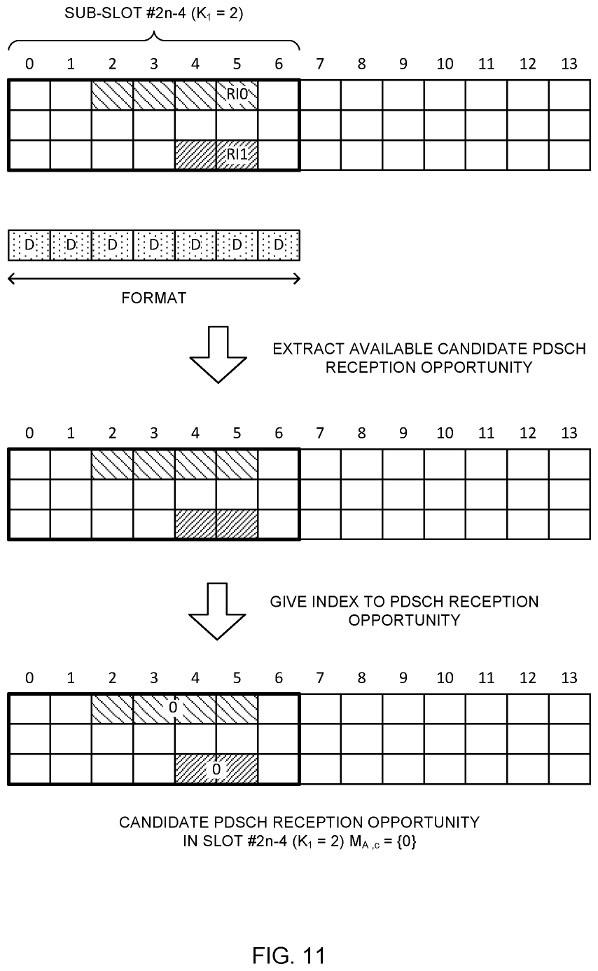

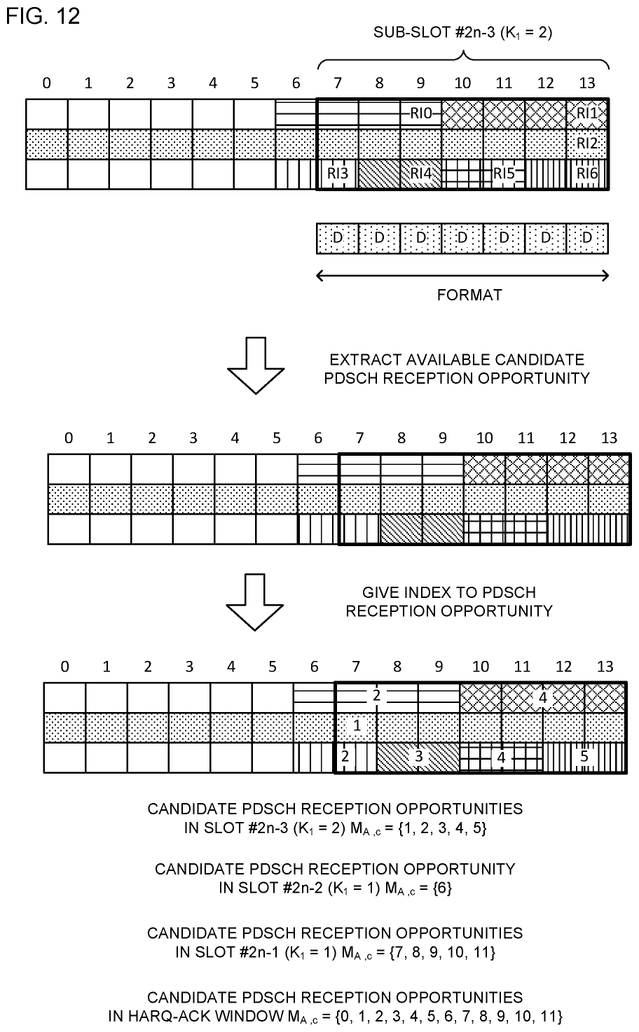

FIGS. 11 and 12 are diagrams illustrating an example of determination of a semi-static HARQ-ACK codebook according to Case 2 of the first aspect. Note that, in FIGS. 11 and 12, it is assumed that the sub-tables 1 and 2 of the PDSCH time domain RA table illustrated in FIG. 10 are used, but the sub-tables are not limited to the illustrated ones.

FIG. 11 illustrates a candidate PDSCH reception opportunity determined by Step 2) described above in the DL sub-slot #2n−4 of FIG. 9 (that is, the first half sub-slot of each DL slot). FIG. 11 illustrates a case where the DL sub-slot #2n−4 has a format including only downlink symbols (D). In the DL sub-slot #2n−4, the UE can use all candidate PDSCH reception opportunities M_{A, c} belonging to the sub-table 1 exemplified in FIG. 10B.

Thus, as illustrated in FIG. 11, all candidate PDSCH reception opportunities M_{A, c} determined on the basis of RI=0 and 1 in the sub-table 1 of FIG. 10B are extracted, and indexes (identifiers or IDs) are given to the extracted candidate PDSCH reception opportunities M_{A, c}. Here, the same index may be given to a plurality of candidate PDSCH reception opportunities M_{A, c} in which at least some symbols overlap (collide).

For example, in FIG. 11, since some symbols of two candidate PDSCH reception opportunities M_{A, c} determined on the basis of RI=0 and 1 in the sub-table 1 of FIG. 10B overlap, the same index “0” is given to these candidate PDSCH reception opportunities M_{A, c}.

A given number (for example, 1 bit) of HARQ-ACK bits may be generated for the candidate PDSCH reception opportunity for each index belonging to the DL sub-slot #2n−4. For example, in FIG. 11, one UE may generate a semi-static HARQ-ACK codebook including a given number of HARQ-ACK bits corresponding to one candidate PDSCH reception opportunity M_{A, c} in the sub-slot #2n−4.

FIG. 12 illustrates a candidate PDSCH reception opportunity determined by Step 2) described above in the DL sub-slot #2n−3 of FIG. 9 (that is, the second half sub-slot of each DL slot). FIG. 12 illustrates a case where the DL sub-slot #2n−3 has a format including only downlink symbols (D). In the DL sub-slot #2n−3, the UE can use all candidate PDSCH reception opportunities M_{A, c} belonging to the sub-table 2 exemplified in FIG. 10C.

Thus, as illustrated in FIG. 12, all candidate PDSCH reception opportunities M_{A, c} determined on the basis of RI=1 to 3 and 5 to 8 in the sub-table 2 of FIG. 10B are extracted, and indexes (identifiers or IDs) are given to the extracted candidate PDSCH reception opportunities M_{A, c}. The way of giving the index is as described above.

Note that, for the DL sub-slot #2n−2 of FIG. 9, similarly to the DL sub-slot #2n−4, a candidate PDSCH reception opportunity can be determined by using the sub-table 1 (see FIG. 11). Further, for the DL sub-slot #2n−1 of FIG. 9, similarly to the DL sub-slot #2n−3, a candidate PDSCH reception opportunity can be determined by using the sub-table 2 (see FIG. 12).

As described above, the candidate PDSCH reception opportunities M_{A, c} in the HARQ-ACK window of FIG. 9 may include the candidate PDSCH reception opportunities with the index “0” in the DL slot #2n−4 of FIG. 11, the indexes “1” to “5” in the DL slot #2n−3 of FIG. 12, a candidate PDSCH reception opportunity with the index “6” in the DL slot #2n−2 (not illustrated), and candidate PDSCH reception opportunities with the indexes “7” to “11” in the DL slot #2n−1 (not illustrated).

The UE may generate a given number of HARQ-ACK bits for a candidate PDSCH reception opportunity for each index in the HARQ-ACK window of FIG. 9. For example, one UE may generate a semi-static HARQ-ACK codebook including a given number of HARQ-ACK bits corresponding to 12 candidate PDSCH reception opportunities M_{A, c} with indexes “0” to “11” in the HARQ-ACK window.

<Case 3>

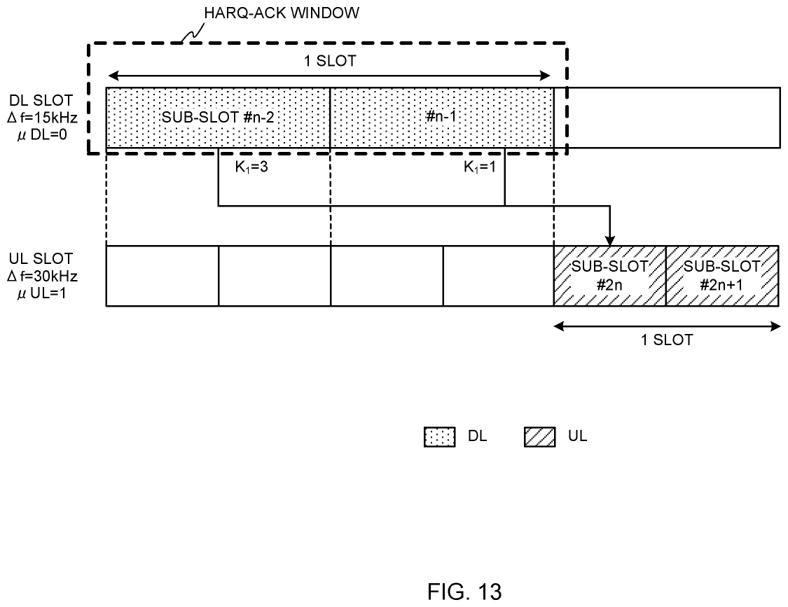

With reference to FIGS. 13 to 15, a description will be given of determination of a set of candidate PDSCH reception opportunities M_{A, c} based on the granularity of the sub-slot level HARQ-ACK timing value K₁ in Case 3 described above. Hereinafter, a description will be mainly given of differences from Case 2 of the first aspect. FIG. 13 is a diagram illustrating an example of determination of a HARQ-ACK window according to Case 3 of the first aspect.

For example, in FIG. 13, a subcarrier spacing 15 kHz is configured in the DL, and a subcarrier spacing 30 kHz is configured in the UL. Further, in FIG. 13, a plurality of UL sub-slots (here, two UL sub-slots #2n and #2n+1) is included in one UL slot. Further, in FIG. 13, the HARQ-ACK timing value K₁ may be given on the basis of the UL sub-slot (with the UL sub-slot as a unit).

As illustrated in FIG. 13, in Case 3, one HARQ-ACK timing value K₁ may be associated with one DL sub-slot. For example, in FIG. 13, a set of HARQ-ACK timing values K₁ includes 3 and 1 (C(K₁)={3, 1}). For this reason, the HARQ-ACK window for a HARQ-ACK bit transmitted in the UL sub-slot #2n includes DL sub-slots #n−2 and #n−1.

Note that the HARQ-ACK timing value K₁ may be associated with one DL virtual sub-slot whose length is equal to the length of the UL sub-slot. In this case, although both K₁=1 and 2 correspond to the DL sub-slot #n−1, either one of the values (here, K₁=1) may be associated. Similarly, although both K₁=3 and 4 correspond to the DL sub-slot #n−2, either one of the values (here, K₁=3) is associated. For this reason, in FIG. 13, the DL sub-slot #n−1 corresponds to K₁=1, and the DL sub-slot #n−2 corresponds to K₁=3.

As described above, in Step 1) of Case 3, the UE may determine the size of the HARQ-ACK window (or DL slots or the number thereof in the HARQ-ACK window) on the basis of the number of HARQ-ACK timing values K₁ in the set described above.

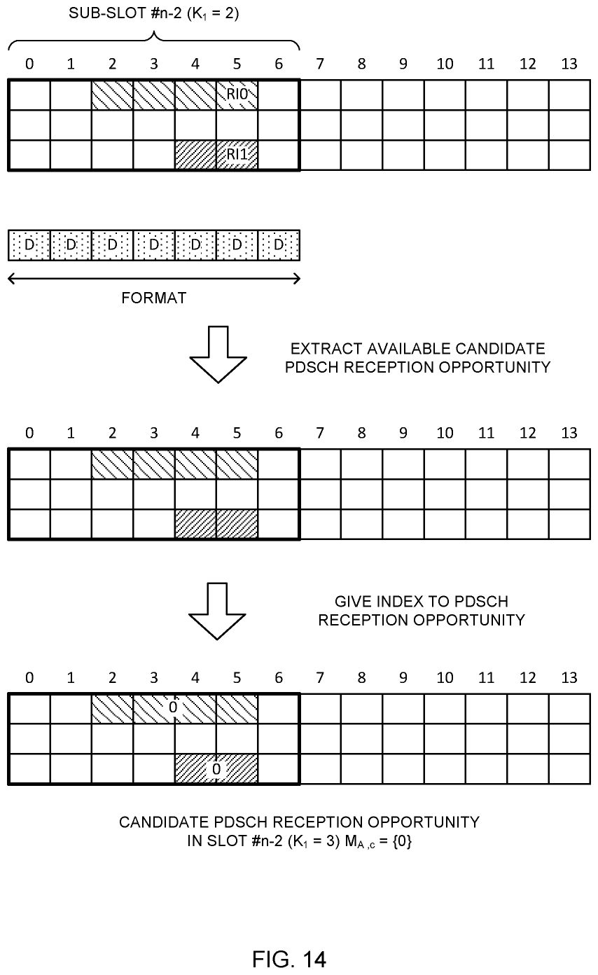

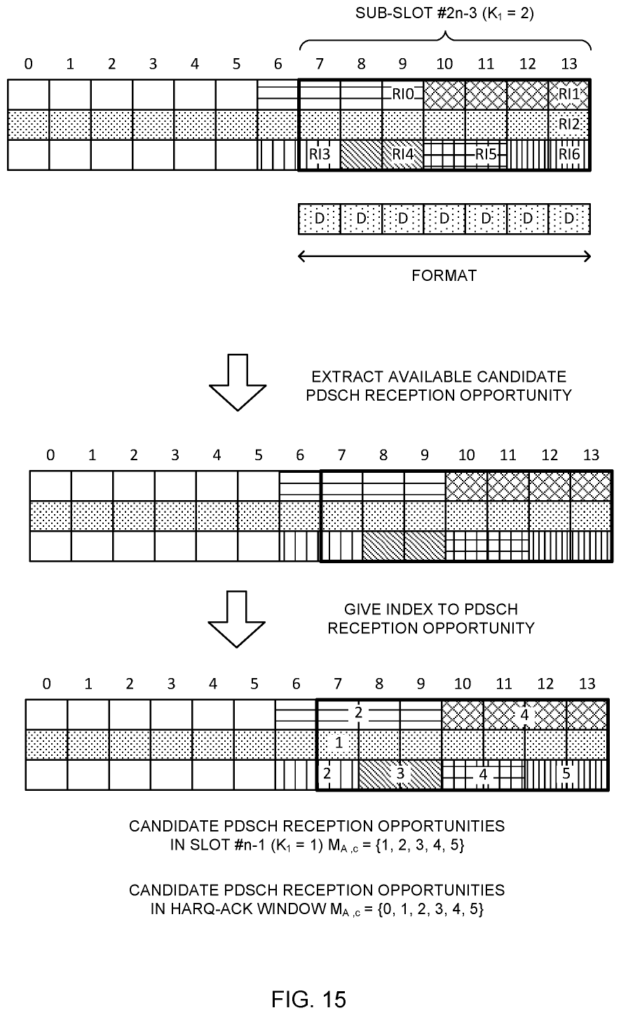

FIGS. 14 and 15 are diagrams illustrating an example of determination of a semi-static HARQ-ACK codebook according to Case 3 of the first aspect. Note that, in FIGS. 14 and 15, it is assumed that the sub-tables 1 and 2 of the PDSCH time domain RA table illustrated in FIGS. 10B and 10C are used, but the sub-tables are not limited to the illustrated ones.

FIG. 14 illustrates a candidate PDSCH reception opportunity determined by Step 2) described above in the DL sub-slot #n−2 of FIG. 13 (that is, the first half sub-slot of each DL slot). FIG. 14 illustrates a case where the DL sub-slot #n−2 has a format including only downlink symbols (D). In the DL sub-slot #n−2, the UE can use all candidate PDSCH reception opportunities M_{A, c} belonging to the sub-table 1 exemplified in FIG. 10B.

Thus, as illustrated in FIG. 14, all candidate PDSCH reception opportunities M_{A, c} determined on the basis of RI=0 and 1 in the sub-table 1 of FIG. 10B are extracted, and indexes (identifiers or IDs) are given to the extracted candidate PDSCH reception opportunities M_{A, c}. The way of giving the index is as described above.

For example, in FIG. 14, since some symbols of two candidate PDSCH reception opportunities M_{A, c} determined on the basis of RI=0 and 1 in the sub-table 1 of FIG. 10B overlap, the same index “0” is given to these candidate PDSCH reception opportunities M_{A, c}.

FIG. 15 illustrates a candidate PDSCH reception opportunity determined by Step 2) described above in the DL sub-slot #n−1 of FIG. 13 (that is, the second half sub-slot of each DL slot). FIG. 15 illustrates a case where the DL sub-slot #n−1 has a format including only downlink symbols (D). In the DL sub-slot #n−1, the UE can use all candidate PDSCH reception opportunities M_{A, c} belonging to the sub-table 2 exemplified in FIG. 10C.

Thus, as illustrated in FIG. 15, all candidate PDSCH reception opportunities M_{A, c} determined on the basis of RI=1 to 3 and 5 to 8 in the sub-table 2 of FIG. 10B are extracted, and indexes (identifiers or IDs) are given to the extracted candidate PDSCH reception opportunities M_{A, c}. The way of giving the index is as described above.

As described above, the candidate PDSCH reception opportunities M_{A, c} in the HARQ-ACK window of FIG. 13 may include the candidate PDSCH reception opportunity with the index “0” in the DL slot #n−2 of FIG. 14 and the indexes “1” to “5” in the DL slot #n−1 of FIG. 14.

The UE may generate a given number of HARQ-ACK bits for a candidate PDSCH reception opportunity for each index in the HARQ-ACK window of FIG. 13. For example, one UE may generate a semi-static HARQ-ACK codebook including a given number of HARQ-ACK bits corresponding to 12 candidate PDSCH receive occasions M_{A, c} with the indexes “0” to “5” in the HARQ-ACK window.

As described above, in the first aspect, in a case where the sub-slot level HARQ-ACK timing value K₁ is used, the semi-static HARQ-ACK codebook can be appropriately generated even if the numerologies of the DL and the UL are different from each other.

(Second Aspect)

In a second aspect, a description will be given of a reference point of the HARQ-ACK timing value K₁. The reference point is a timing serving as a reference of the HARQ-ACK timing value K₁, and may be referred to as a reference timing or the like.

A UL sub-slot may be defined on the basis of the number of symbols (UL symbols) to which a UL numerology is applied.

Further, the reference point of the HARQ-ACK timing value K₁ may be determined on the basis of a UL sub-slot overlapping a PDSCH or a PDSCH of semi-persistent scheduling (SPS) (for example, the last of the UL sub-slot).

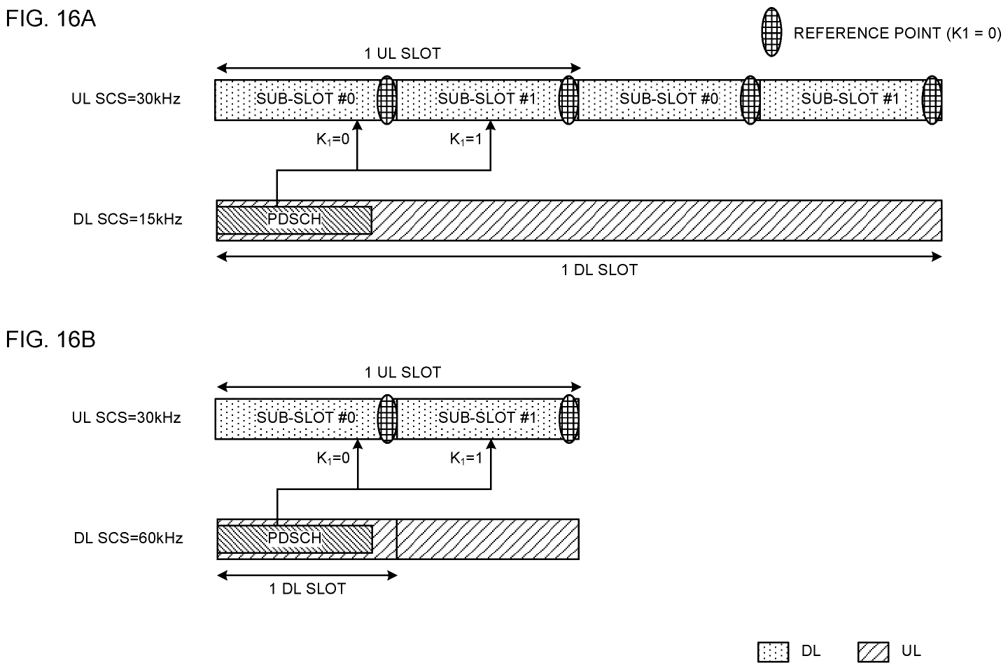

FIGS. 16A and 16B are diagrams illustrating an example of a reference point of the HARQ-ACK timing value K₁ according to the second aspect. FIG. 16A illustrates an example of the reference point in Case 3 described above. In FIG. 16A, for example, it is assumed that the PDSCH or the SPS PDSCH is scheduled in a DL slot with a subcarrier spacing of 15 kHz.

As illustrated in FIG. 16A, a reference point for the HARQ-ACK timing K₁=0 may be the last of the UL sub-slot #0 overlapping the PDSCH or SPS PDSCH. Specifically, the reference point for the HARQ-ACK timing value K₁=0 may be the last of the UL sub-slot overlapping with the last symbol of the PDSCH or SPS PDSCH.

As illustrated in FIG. 16A, the HARQ-ACK timing value K₁ may be counted for each UL sub-slot from the reference point. For example, in FIG. 16A, K₁=0 corresponds to the UL sub-slot #0, and K₁=1 corresponds to the UL sub-slot #1.

FIG. 16B illustrates an example of the reference point in Case 2. In FIG. 16B, for example, it is assumed that the PDSCH or the SPS PDSCH is scheduled in a DL slot with a subcarrier spacing of 60 kHz.

As illustrated in FIG. 16B, the reference point for the HARQ-ACK timing K₁=0 may be the last of the UL sub-slot #0 overlapping the PDSCH or SPS PDSCH. Specifically, the reference point for the HARQ-ACK timing value K₁=0 may be the last of the UL sub-slot overlapping with the last symbol of the PDSCH or SPS PDSCH.

As illustrated in FIG. 16B, the HARQ-ACK timing value K₁ may be counted for each UL sub-slot from the reference point. For example, in FIG. 16B, K₁=0 corresponds to the UL sub-slot #0, and K₁=1 corresponds to the UL sub-slot #1.

In the second aspect, in a case where the semi-static HARQ-ACK codebook is determined on the basis of the sub-slot level HARQ-ACK timing value K₁, the UE may use at least one parameter of the a) to d) described above. In the second aspect, a description will be mainly given of differences from the first aspect.

<Case 2>

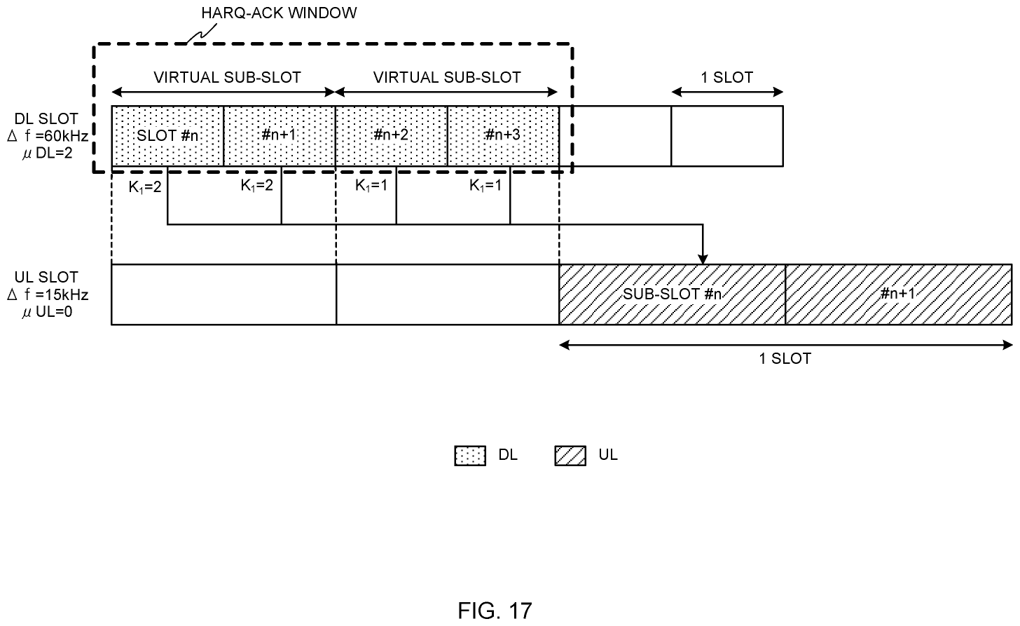

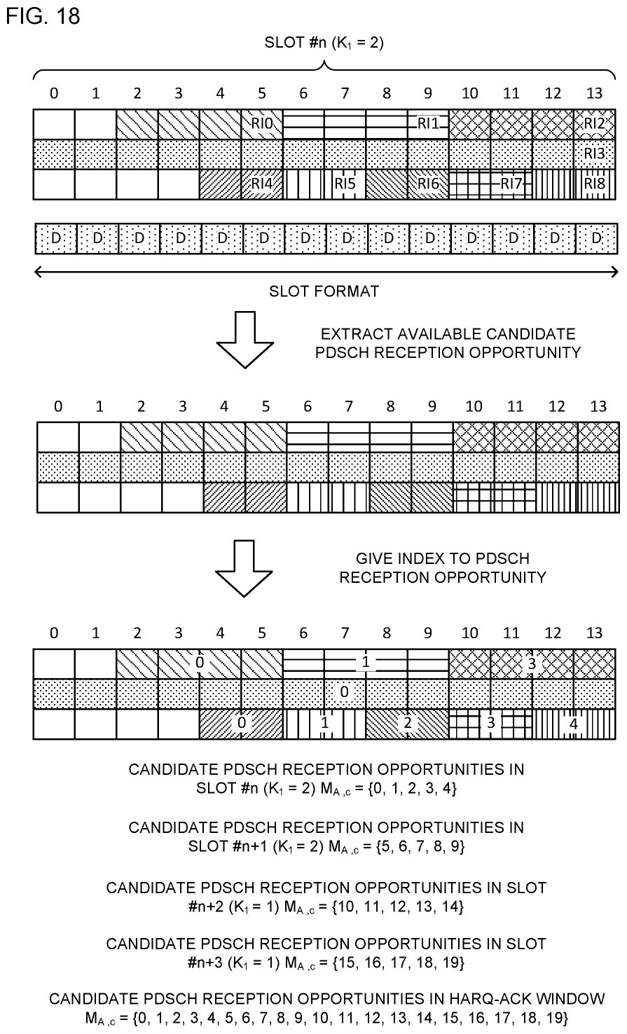

With reference to FIGS. 17 to 18, a description will be given of determination of a set of candidate PDSCH reception opportunities M_{A, c} based on the granularity of the sub-slot level HARQ-ACK timing value K₁ in Case 2 described above. Hereinafter, a description will be mainly given of differences from Step 1) and 2) of the first aspect. FIG. 17 is a diagram illustrating an example of determination of a HARQ-ACK window according to Case 2 according to the second aspect.

For example, in FIG. 17, a subcarrier spacing 60 kHz is configured in the DL, and a subcarrier spacing 15 kHz is configured in the UL. In FIG. 17, a plurality of UL sub-slots (here, two UL sub-slots #n and #n+1) is included in one UL slot.

As illustrated in FIG. 17, in Case 2, one HARQ-ACK timing value K₁ may be associated with one virtual DL sub-slot. Further, one virtual DL sub-slot may have the same time length as one UL sub-slot.

For example, in FIG. 17, the subcarrier spacing 60 kHz of the DL is four times the subcarrier spacing 15 kHz of the UL. Thus, the time length of one DL slot is ¼ times the time length of one UL slot, and the time length of one UL sub-slot corresponds to two DL slots. For this reason, one DL virtual slot may include two DL slots.

As described above, in Case 2 of the second aspect, since one virtual DL sub-slot includes a plurality of DL slots, one HARQ-ACK timing value K₁ may be associated with the plurality of DL slots.

For example, in FIG. 17, a set of HARQ-ACK timing values K₁ includes 2 and 1 (C(K₁)={2, 1}). For this reason, the HARQ-ACK window for a HARQ-ACK bit transmitted in the UL sub-slot #n includes DL slots #n, #n+1, #n+2, #n+3 in two virtual DL sub-slots associated with the HARQ-ACK timing values K₁=1 and 2.

As described above, in Step 1) of Case 2, the UE may determine the size of the HARQ-ACK window (or DL slots or the number thereof in the HARQ-ACK window) on the basis of at least one of the number of HARQ-ACK timing values K₁ in the set described above or the number of DL slots associated with each HARQ-ACK timing value K₁ (the number of DL slots in a virtual sub-slot).

FIG. 18 is a diagram illustrating an example of determination of a semi-static HARQ-ACK codebook according to Case 2 of the second aspect. Note that, in FIG. 18, it is assumed that the PDSCH time domain RA table illustrated in FIG. 2 is used, but the PDSCH time domain RA table is not limited to the illustrated one.

FIG. 18 illustrates a candidate PDSCH reception opportunity determined by the DL slot #n of FIG. 17. FIG. 18 illustrates a case where the DL slot #n has a format including only downlink symbols (D). In the DL slot #n, the UE can use all candidate PDSCH reception opportunities M_{A, c} belonging to the PDSCH time domain RA table exemplified in FIG. 2.

Thus, as illustrated in FIG. 18, all candidate PDSCH reception opportunities M_{A, c} determined on the basis of RI=0 to 8 in the PDSCH time domain RA table of FIG. 2 are extracted, and indexes (identifiers or IDs) are given to the extracted candidate PDSCH reception opportunities M_{A, c}. Giving the index is as described in FIG. 3.

The candidate PDSCH reception opportunities M_{A, c} in the slot #n determined as described above include candidate PDSCH reception opportunities identified by different indexes (values) “0” to “4”.

Similarly, in a case where slots #n+1, #n+2, #n+3 each include downlink symbols (D) and all candidate PDSCH reception opportunities M_{A, c} belonging to the PDSCH time domain RA table illustrated in FIG. 2 are available, the candidate PDSCH reception opportunities M_{A, c} in the slot #n+1 include candidate PDSCH reception opportunities identified by different indexes (values) “5” to “9”.

Further, the candidate PDSCH reception opportunities M_{A, c} in the slot #n+2 include candidate PDSCH reception opportunities identified by different indexes (values) “10” to “14”. Further, the candidate PDSCH reception opportunities M_{A, c} in the slot #n+3 include candidate PDSCH reception opportunities identified by different indexes (values) “15” to “19”.

From the above, the candidate PDSCH reception opportunities M_{A, c} in the HARQ-ACK window of FIG. 17 include the candidate PDSCH reception opportunities identified by the different indexes (values) “0” to “19”. One UE may generate a semi-static HARQ-ACK codebook including a given number of HARQ-ACK bits corresponding to the 20 candidate PDSCH reception opportunities M_{A, c} with indexes “0” to “19” in the HARQ-ACK window.

<Case 3>

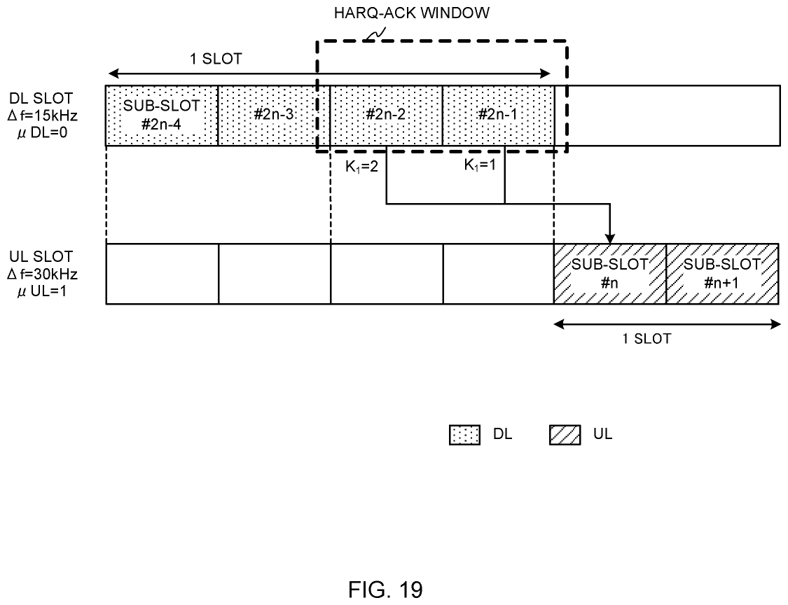

With reference to FIGS. 19 to 21, a description will be given of determination of a set of candidate PDSCH reception opportunities M_{A, c} based on the granularity of the sub-slot level HARQ-ACK timing value K₁ in Case 3 described above. Hereinafter, a description will be mainly given of differences from Case 3 of the first aspect. FIG. 19 is a diagram illustrating an example of determination of a HARQ-ACK window according to Case 3 described above according to the second aspect.

For example, in FIG. 19, a subcarrier spacing 15 kHz is configured in the DL, and a subcarrier spacing 30 kHz is configured in the UL. Further, in FIG. 19, a plurality of UL sub-slots (here, two UL sub-slots #n and #n+1) are included in one UL slot. Further, in FIG. 19, the HARQ-ACK timing value K₁ may be given on the basis of the UL sub-slot (with the UL sub-slot as a unit).

As illustrated in FIG. 19, in Case 3, one HARQ-ACK timing value K₁ may be associated with one DL sub-slot. For example, in FIG. 19, a set of HARQ-ACK timing values K₁ includes 2 and 1 (C(K₁)={2, 1}). For this reason, the HARQ-ACK window for a HARQ-ACK bit transmitted in the UL sub-slot #n includes DL sub-slots #2n−2 and #2n−1. In FIG. 19, one DL sub-slot=one virtual DL sub-slot, but the present invention is not limited thereto.

As described above, in Step 1) of Case 3, the UE may determine the size of the HARQ-ACK window (or DL slots or the number thereof in the HARQ-ACK window) on the basis of the number of HARQ-ACK timing values K₁ in the set described above.

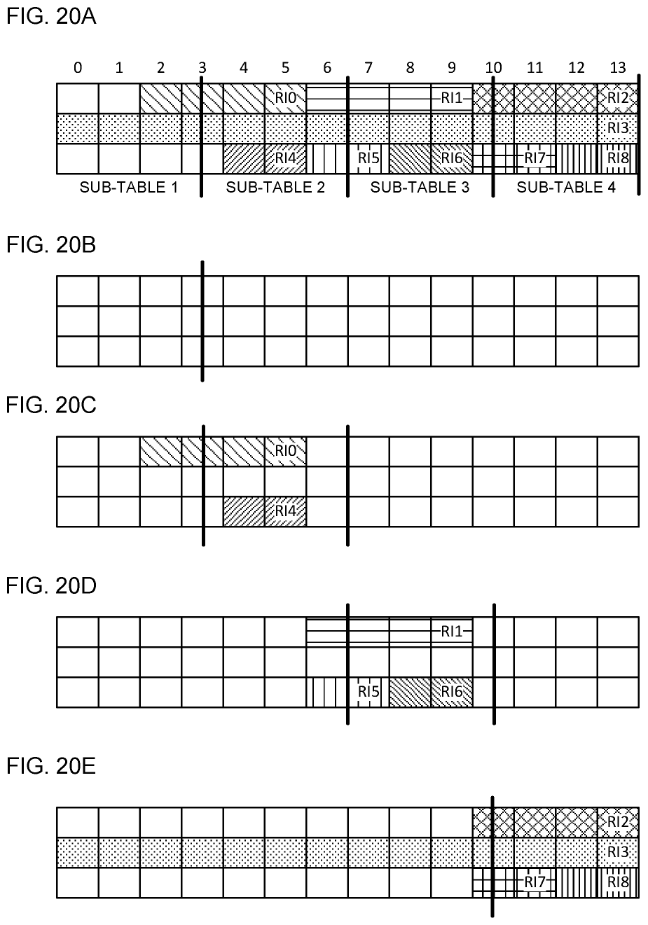

FIGS. 20A to 20E are diagrams illustrating an example of a PDSCH time domain RA table according to the second aspect. FIG. 20A illustrates candidate PDSCH reception opportunities with RI=0 to 8 specified by the PDSCH time domain RA table (see, for example, FIG. 2).

As illustrated in FIGS. 20B to 20E, the PDSCH time domain RA table (see, for example, FIG. 2) may be divided into four sub-tables on the basis of the granularity of the HARQ-ACK timing value K₁. The number of sub-tables may be equal to the number of virtual DL sub-slots included in one DL sub-slot.

For example, in FIG. 19, four virtual DL sub-slots are included in one DL sub-slot. As illustrated in FIG. 19, the time length of each virtual DL sub-slot may be equal to the time length of the UL sub-slot. For this reason, four sub-tables 1 to 4 illustrated in FIGS. 20B to 20E may be generated. Note that details of the generation of the sub-table are as described in FIGS. 10A to 10C.

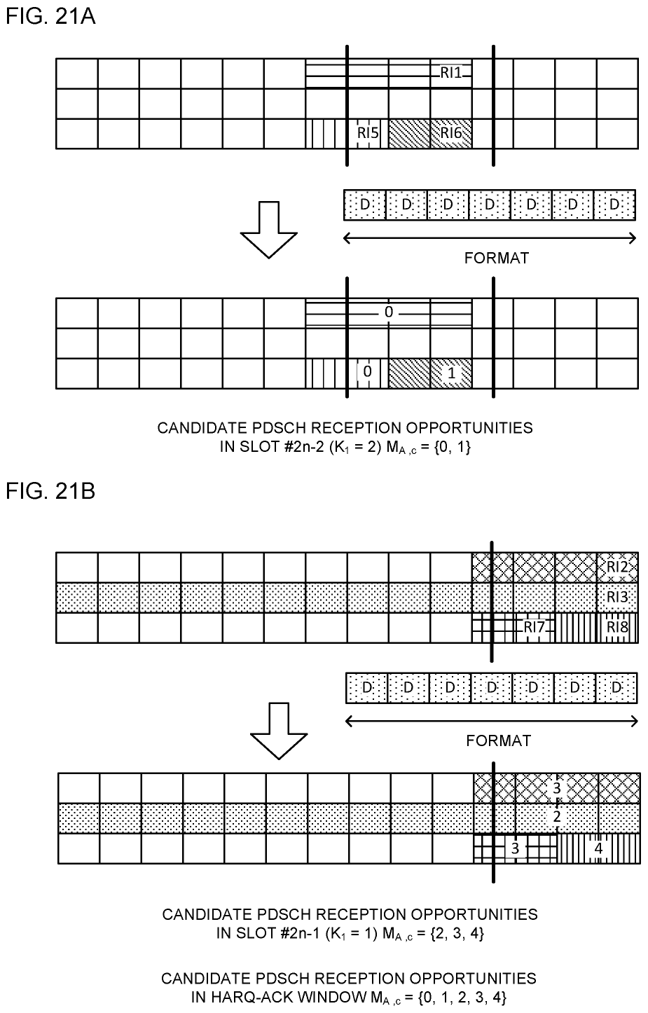

FIGS. 21A and 21B are diagrams illustrating an example of determination of a semi-static HARQ-ACK codebook according to Case 3 of the second aspect. Note that, in FIG. 21, it is assumed that the sub-table 1 to 4 of the PDSCH time domain RA table illustrated in FIGS. 20B to 20E is used, but the sub-tables are not limited to the illustrated ones.

FIG. 21A illustrates a candidate PDSCH reception opportunity determined by Step 2) described above in the DL sub-slot #2n−2 of FIG. 19. FIG. 21A illustrates a case where the DL sub-slot #2n−2 has a format including only downlink symbols (D). In the DL sub-slot #2n−2, the UE can use all candidate PDSCH reception opportunities M_{A, c} belonging to the sub-table 3 exemplified in FIG. 20D.

Thus, as illustrated in FIG. 21A, all candidate PDSCH reception opportunities M_{A, c} determined on the basis of RI=0 and 4 in the sub-table 1 of FIG. 20D are extracted, and indexes (identifiers or IDs) are given to the extracted candidate PDSCH reception opportunities M_{A, c}. The way of giving the index is as described above.

For example, in FIG. 21A, candidate PDSCH reception opportunities M_{A, c} for the DL sub-slot #2n−2 of FIG. 19 include candidate PDSCH reception opportunities with different indexes “0” and “1”.

FIG. 21B illustrates a candidate PDSCH reception opportunity determined by Step 2) described above in the DL sub-slot #2n−1 of FIG. 19. FIG. 21B illustrates a case where the DL sub-slot #2n−1 has a format including only downlink symbols (D). In the DL sub-slot #2n−1, the UE can use all candidate PDSCH reception opportunities M_{A, c} belonging to the sub-table 4 exemplified in FIG. 20E.

Thus, as illustrated in FIG. 21B, all candidate PDSCH reception opportunities M_{A, c} determined on the basis of RI=2, 3, 7, and 8 in the sub-table 4 of FIG. 20B are extracted, and indexes (identifiers or IDs) are given to the extracted candidate PDSCH reception opportunities M_{A, c}. The way of giving the index is as described above.

For example, in FIG. 21B, candidate PDSCH reception opportunities M_{A, c} for the DL sub-slot #2n−1 of FIG. 19 include candidate PDSCH reception opportunities with different indexes “2,” “3,” and “4”.

From the above, the candidate PDSCH reception opportunities M_{A, c} in the HARQ-ACK window of FIG. 19 include the candidate PDSCH reception opportunities identified by the different indexes (values) “0” to “4”. The UE may generate a given number of HARQ-ACK bits for a candidate PDSCH reception opportunity for each index.

As described above, in the second aspect, in a case where the sub-slot level HARQ-ACK timing value K₁ is used, the semi-static HARQ-ACK codebook can be appropriately generated even if the numerologies of the DL and the UL are different from each other.

(Radio Communication System)

Hereinafter, a configuration of a radio communication system according to one embodiment of the present disclosure will be described. In this radio communication system, communication is performed using one or a combination of the radio communication methods according to the embodiments of the present disclosure.

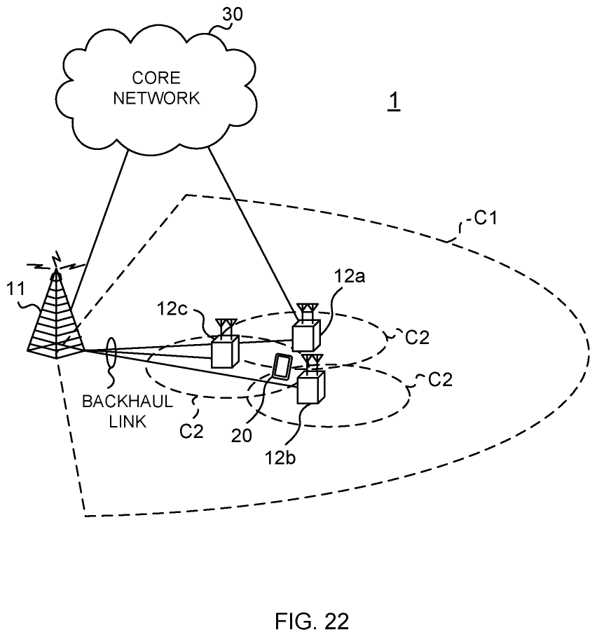

FIG. 22 is a diagram illustrating an example of a schematic configuration of the radio communication system according to one embodiment. A radio communication system 1 may be a system that implements communication by using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (Evolved Universal Terrestrial Radio Access (E-UTRA)) and NR (E-UTRA-NR Dual Connectivity (EN-DC)), dual connectivity between NR and LTE (NR-E-UTRA Dual Connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is a MN, and an LTE (E-UTRA) base station (eNB) is a SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are arranged within the macro cell C1 and that form small cells C2 narrower than the macro cell C1. A user terminal 20 may be located in at least one cell. The arrangement, number, and the like of cells and the user terminals 20 are not limited to the aspects illustrated in the figure. Hereinafter, the base stations 11 and 12 will be collectively referred to as “base stations 10” in a case where these are not distinguished from each other.

The user terminal 20 may be connected to at least one of the plurality of base stations 10. The user terminal 20 may use at least one of carrier aggregation (CA) using a plurality of component carriers (CC) or dual connectivity (DC).

Each CC may be included in at least one of a frequency range 1 (FR 1) or a second frequency range 2 (FR 2). The macro cell C1 may be included in the FR 1, and the small cell C2 may be included in the FR 2. For example, the FR 1 may be a frequency range of 6 GHz or less (sub-6 GHz), and the FR 2 may be a frequency range higher than 24 GHz (above-24 GHz). Note that the frequency ranges, definitions, and the like of the FR 1 and FR 2 are not limited thereto, and, for example, the FR 1 may correspond to a frequency range higher than the FR 2.

Further, the user terminal 20 may perform communication in each CC using at least one of time division duplex (TDD) or frequency division duplex (FDD).

The plurality of base stations 10 may be connected to each other by wire (for example, an optical fiber or an X2 interface in compliance with common public radio interface (CPRI)) or by radio (for example, NR communication). For example, in a case where the NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), a next generation core (NGC), or the like.

The user terminal 20 may be a terminal corresponding to at least one of communication methods such as LTE, LTE-A, or 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), or the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH) shared by the user terminals 20, a physical broadcast channel (PBCH), a physical downlink control channel (PDCCH), or the like may be used.

Further, in the radio communication system 1, as an uplink channel, a physical uplink shared channel (PUSCH) shared by the user terminals 20, a physical uplink control channel (PUCCH), a physical random access channel (PRACH), or the like may be used.

The PDSCH transmits user data, higher layer control information, a system information block (SIB), and the like. The PUSCH may transmit user data, higher layer control information, and the like. Further, the PBCH may transmit a master information block (MIB).

The PDCCH may transmit lower layer control information. The lower layer control information may include, for example, downlink control information (DCI) including scheduling information of at least one of the PDSCH or the PUSCH.

Note that DCI that schedules the PDSCH may be referred to as DL assignment, DL DCI, or the like, and DCI that schedules the PUSCH may be referred to as UL grant, UL DCI, or the like. Note that the PDSCH may be replaced with DL data, and the PUSCH may be replaced with UL data.

A control resource set (CORESET) and a search space may be used to detect the PDCCH. The CORESET corresponds to a resource that searches for DCI. The search space corresponds to a search area and a search method for PDCCH candidates. One CORESET may be associated with one or a plurality of search spaces. The UE may monitor the CORESET related to a certain search space on the basis of search space configuration.

One search space may correspond to a PDCCH candidate corresponding to one or a plurality of aggregation levels. One or a plurality of search spaces may be referred to as a search space set. Note that “search space”, “search space set”, “search space configuration”, “search space set configuration”, “CORESET”, “CORESET configuration”, and the like in the present disclosure may be replaced with each other.

Uplink control information (UCI) including at least one of channel state information (CSI), delivery confirmation information (which may be referred to as, for example, hybrid automatic repeat request acknowledgement (HARQ-ACK), ACK/NACK, or the like), scheduling request (SR), or the like may be transmitted by the PUCCH. By means of the PRACH, a random access preamble for establishing a connection with a cell may be transmitted.

Note that in the present disclosure, downlink, uplink, and the like may be expressed without “link”. Further, various channels may be expressed without adding “physical” at the beginning thereof.

In the radio communication system 1, a synchronization signal (SS), a downlink reference signal (DL-RS), and the like may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like may be transmitted as the DL-RS.

The synchronization signal may be, for example, at least one of a primary synchronization signal (PSS) or a secondary synchronization signal (SSS). A signal block including the SS (PSS, SSS) and the PBCH (and the DMRS for the PBCH) may be referred to as an SS/PBCH block, an SS block (SSB), and the like. Note that the SS, the SSB, or the like may also be referred to as a reference signal.

Further, in the radio communication system 1, a sounding reference signal (SRS), the demodulation reference signal (DMRS), and the like may be transmitted as an uplink reference signal (UL-RS). Note that the DMRS may be referred to as a “user terminal-specific reference signal (UE-specific Reference Signal).”

(Base Station)

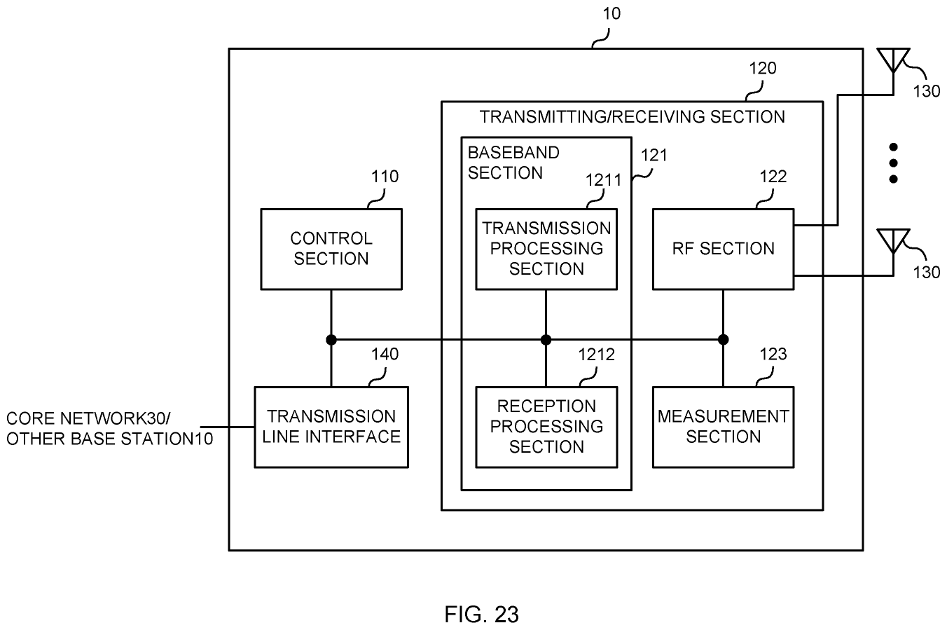

FIG. 23 is a diagram illustrating an example of a configuration of a base station according to one embodiment. The base station 10 includes a control section 110, a transmitting/receiving section 120, a transmission/reception antenna 130, and a transmission line interface 140. Note that one or more each of the control sections 110, the transmitting/receiving sections 120, the transmission/reception antennas 130, and the transmission line interfaces 140 may be included.

Note that this example mainly describes functional blocks of characteristic parts in the present embodiment, and it may be assumed that the base station 10 also includes other functional blocks necessary for radio communication. A part of processing of each section described below may be omitted.

The control section 110 controls the entire base station 10. The control section 110 can include a controller, a control circuit, and the like that are described on the basis of common recognition in the technical field related to the present disclosure.

The control section 110 may control signal generation, scheduling (for example, resource allocation, mapping), and the like. The control section 110 may control transmission/reception, measurement, and the like using the transmitting/receiving section 120, the transmission/reception antenna 130, and the transmission line interface 140. The control section 110 may generate data, control information, a sequence, and the like to be transmitted as signals, and may transfer the data, the control information, the sequence, and the like to the transmitting/receiving section 120. The control section 110 may perform call processing (such as configuration or release) of a communication channel, state management of the base station 10, management of a radio resource, and the like.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmitting/receiving section 120 may be formed as an integrated transmitting/receiving section, or may include a transmitting section and a receiving section. The transmitting section may include the transmission processing section 1211 and the RF section 122. The receiving section may include the reception processing section 1212, the RF section 122, and the measurement section 123.

The transmission/reception antenna 130 can include an antenna described on the basis of common recognition in the technical field related to the present disclosure, for example, an array antenna or the like.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a transmission beam and a reception beam by using digital beam forming (for example, precoding), analog beam forming (for example, phase rotation), or the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like, for example, on data, control information, and the like acquired from the control section 110, to generate a bit string to be transmitted.

The transmitting/receiving section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmitting/receiving section 120 (RF section 122) may perform modulation to a radio frequency range, filtering processing, amplification, and the like on the baseband signal, to transmit a signal in the radio frequency range via the transmission/reception antenna 130.

Meanwhile, the transmitting/receiving section 120 (RF section 122) may perform amplification, filtering processing, demodulation to a baseband signal, and the like on the signal in the radio frequency range received by the transmission/reception antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal to acquire user data and the like.

The transmitting/receiving section 120 (measurement section 123) may perform measurement on the received signal. For example, the measurement section 123 may perform radio resource management (RRM) measurement, channel state information (CSI) measurement, and the like on the basis of the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may perform transmission/reception (backhaul signaling) of a signal to/from apparatuses, other base stations 10, and the like included in the core network 30, and may perform acquisition, transmission, and the like of user data (user plane data), control plane data, and the like for the user terminal 20.

Note that the transmitting section and the receiving section of the base station 10 in the present disclosure may include at least one of the transmitting/receiving section 120, the transmission/reception antenna 130, or the transmission line interface 140.

Note that the transmitting/receiving section 120 may receive a codebook (semi-static HARQ-ACK codebook). The transmitting/receiving section 120 may receive the codebook by using the PUCCH or the PUSCH.

Note that the transmitting/receiving section 120 may transmit information indicating the granularity (time unit) of the HARQ-ACK timing value. The information may be included in system information or the RRC parameter.

Note that the control section 110 may control transmission in the PDSCH on the basis of the received codebook.

(User Terminal)

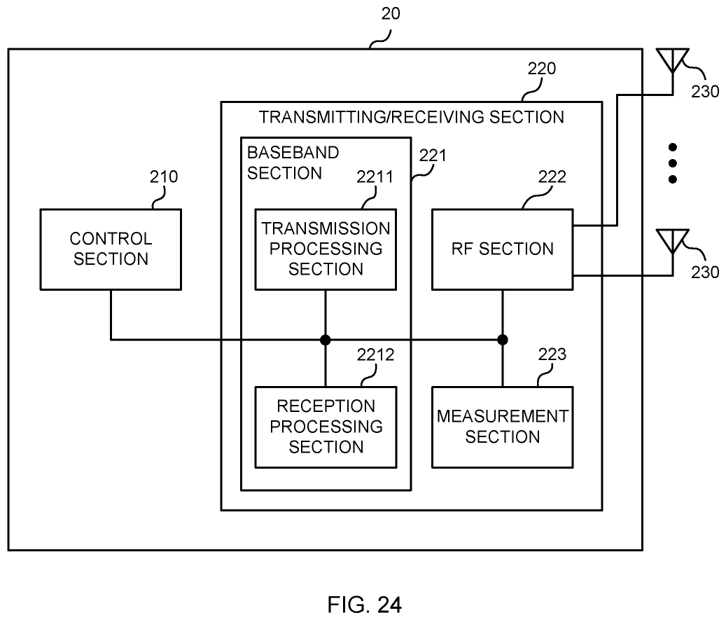

FIG. 24 is a diagram illustrating an example of a configuration of a user terminal according to one embodiment. The user terminal 20 includes a control section 210, a transmitting/receiving section 220, and a transmission/reception antenna 230. Note that one or more each of the control sections 210, the transmitting/receiving sections 220, and the transmission/reception antennas 230 may be included.

Note that this example mainly describes functional blocks of characteristic parts of the present embodiment, and it may be assumed that the user terminal 20 also includes other functional blocks necessary for radio communication. A part of processing of each section described below may be omitted.

The control section 210 controls the entire user terminal 20. The control section 210 can include a controller, a control circuit, and the like that are described on the basis of common recognition in the technical field related to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data to be transmitted as a signal, control information, a sequence, and the like, and may transfer the data, the control information, the sequence, and the like to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can include a transmitter/receiver, an RF circuit, a baseband circuit, a filter, a phase shifter, a measurement circuit, a transmission/reception circuit, and the like that are described on the basis of common recognition in the technical field related to the present disclosure.

The transmitting/receiving section 220 may be formed as an integrated transmitting/receiving section, or may include a transmitting section and a receiving section. The transmitting section may include the transmission processing section 2211 and the RF section 222. The receiving section may include the reception processing section 2212, the RF section 222, and the measurement section 223.

The transmission/reception antenna 230 can include an antenna described on the basis of common recognition in the technical field related to the present disclosure, for example, an array antenna or the like.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a transmission beam and a reception beam by using digital beam forming (for example, precoding), analog beam forming (for example, phase rotation), or the like.

The transmitting/receiving section 220 (transmission processing section 2211) may perform PDCP layer processing, RLC layer processing (for example, RLC retransmission control), MAC layer processing (for example, HARQ retransmission control), and the like, for example, on data, control information, and the like acquired from the control section 210, to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

Note that whether or not to apply DFT processing may be determined on the basis of configuration of transform precoding. In a case where transform precoding is enabled for a channel (for example, PUSCH), the transmitting/receiving section 220 (transmission processing section 2211) may perform DFT processing as the transmission processing in order to transmit the channel using a DFT-s-OFDM waveform. In a case where it is not the case, DFT processing need not be performed as the transmission processing.

The transmitting/receiving section 220 (RF section 222) may perform modulation to a radio frequency range, filtering processing, amplification, and the like on the baseband signal, to transmit a signal in the radio frequency range via the transmission/reception antenna 230.

Meanwhile, the transmitting/receiving section 220 (RF section 222) may perform amplification, filtering processing, demodulation to a baseband signal, and the like on the signal in the radio frequency range received by the transmission/reception antenna 230.

The transmitting/receiving section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal to acquire user data and the like.

The transmitting/receiving section 220 (measurement section 223) may perform measurement on the received signal. For example, the measurement section 223 may perform RRM measurement, CSI measurement, and the like on the basis of the received signal. The measurement section 223 may measure received power (for example, RSRP), received quality (for example, RSRQ, SINR, SNR), signal strength (for example, RSSI), propagation path information (for example, CSI), and the like. The measurement result may be output to the control section 210.

Note that the transmitting section and the receiving section of the user terminal 20 in the present disclosure may include at least one of the transmitting/receiving section 220, the transmission/reception antenna 230, and the transmission line interface 240.

Note that the transmitting/receiving section 220 may transmit a codebook (semi-static HARQ-ACK codebook). The transmitting/receiving section 220 may transmit the codebook by using the PUCCH or the PUSCH.

Note that the transmitting/receiving section 220 may receive information indicating the granularity (time unit) of the HARQ-ACK timing value. The information may be included in system information or the RRC parameter.

The control section 210 may determine a set of one or more candidate opportunities (candidate PDSCH reception opportunities) for receiving a downlink shared channel available in the time unit on the basis of a HARQ-ACK timing value using a time unit shorter than the slot.

Specifically, in a case where different subcarrier spacings are configured for the uplink and the downlink, on the basis of a HARQ-ACK timing value indicated by the number of first time units shorter than a slot for the uplink, the control section 210 may determine a set of one or more candidate opportunities for receiving the downlink shared channel within a given number of the first time units.

The control section 210 may control determination of a codebook based on the set of the candidate opportunities.

The control section 210 may determine the set on the basis of a format of the time unit. Further, the control section 210 may determine the set of the candidate opportunities on the basis of time domain resource allocation for each time unit in the slot.

In a case where the subcarrier spacing in the uplink is less than the subcarrier spacing in the downlink, the HARQ-ACK timing value may be associated with a plurality of slots for the downlink or a plurality of second time units for the downlink. Each of the plurality of second time units may be shorter than one slot for the downlink.

In a case where the subcarrier spacing in the uplink is greater than the subcarrier spacing in the downlink, the HARQ-ACK timing value may be associated with a single second time unit shorter than one slot for the downlink. The second time unit may be shorter than one slot for the downlink.

The control section 210 may determine a reference point of the HARQ-ACK timing value on the basis of the time unit for the uplink that overlaps with the last symbol of the downlink shared channel.

(Hardware Configuration)

Note that the block diagrams that have been used to describe the above embodiments illustrate blocks in functional units. These functional blocks (configuration sections) may be implemented in any combinations of at least one of hardware or software. Further, the method for implementing each functional block is not particularly limited. That is, each functional block may be implemented by a single apparatus physically or logically aggregated, or may be implemented by directly or indirectly connecting two or more physically or logically separate apparatuses (using wire, radio, or the like, for example) together and using these plural apparatuses. The functional blocks may be implemented by combining software with the above-described single apparatus or the above-described plurality of apparatuses.

Here, the function includes, but is not limited to, deciding, determining, judging, calculating, computing, processing, deriving, investigating, searching, ascertaining, receiving, transmitting, outputting, accessing, solving, selecting, choosing, establishing, comparing, assuming, expecting, considering, broadcasting, notifying, communicating, forwarding, configuring, reconfiguring, allocating, mapping, and assigning. For example, a functional block (configuration section) that causes transmission to function may be referred to as a transmitting section (transmitting unit), a transmitter, and the like. In any case, as described above, the implementation method is not particularly limited.

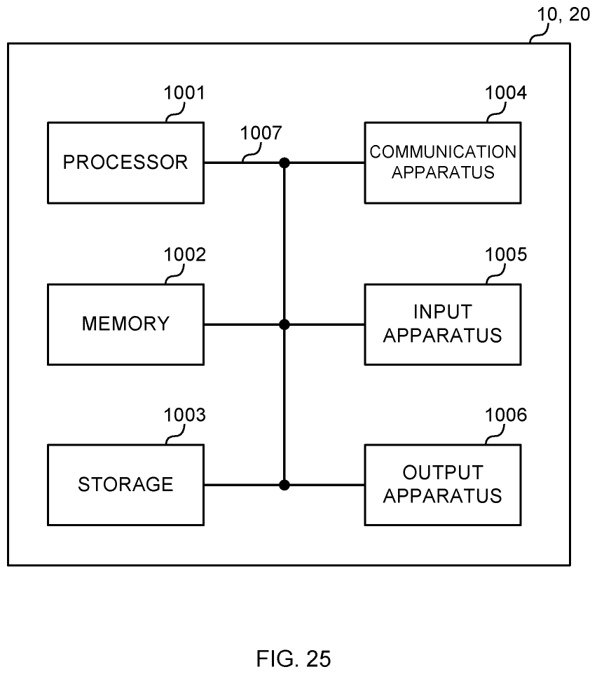

For example, the base station, the user terminal, and the like according to one embodiment of the present disclosure may function as a computer that executes the processing of the radio communication method of the present disclosure. FIG. 25 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, and a unit can be replaced with each other. The hardware configuration of the base station 10 and the user terminal 20 may include one or a plurality of apparatuses illustrated in the figure, or does not have to include some apparatuses.

For example, although only one processor 1001 is illustrated, a plurality of processors may be provided. Further, the processing may be executed by one processor, or the processing may be executed by two or more processors simultaneously, sequentially, or using another method. Note that the processor 1001 may be implemented by one or more chips.

Each of functions of the base station 10 and the user terminal 20 is implemented by, for example, the processor 1001 executing an operation by reading given software (program) on hardware such as the processor 1001 or the memory 1002, controlling communication via the communication apparatus 1004, and controlling at least one of reading or writing of data in the memory 1002 and the storage 1003.

The processor 1001 may control the entire computer by, for example, causing an operating system to be operated. The processor 1001 may include a central processing unit (CPU) including an interface with peripheral equipment, a control device, an arithmetic device, a register, and the like. For example, at least a part of the above-described control section 110 (210), transmitting/receiving section 120 (220), or the like may be implemented by the processor 1001.

Further, the processor 1001 reads programs (program codes), software modules, or data, from at least one of the storage 1003 or the communication apparatus 1004, into the memory 1002, and executes various types of processing in accordance with these. As the program, a program to cause a computer to execute at least a part of the operation described in the above-described embodiment is used. For example, the control section 110 (210) may be implemented by a control program that is stored in the memory 1002 and operates in the processor 1001, and other functional blocks may be implemented similarly.

The memory 1002 is a computer-readable recording medium, and may include, for example, at least one of a read only memory (ROM), an erasable programmable ROM (EPROM), an electrically EPROM (EEPROM), a random access memory (RAM) and/or other appropriate storage media. The memory 1002 may be referred to as a register, a cache, a main memory (main storage apparatus), or the like. The memory 1002 can store programs (program codes), software modules, and the like that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disc, a Blu-ray (registered trademark) disk), a removable disk, a hard disk drive, a smart card, a flash memory device (for example, a card, a stick, a key drive), a magnetic stripe, a database, a server, and other appropriate storage media. The storage 1003 may be referred to as an auxiliary storage apparatus.

The communication apparatus 1004 is hardware (transmission/reception device) for performing inter-computer communication through at least one of a wired network or a radio network, and may be referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the above-described transmitting/receiving section 120 (220), transmission/reception antenna 130 (230), and the like may be implemented by the communication apparatus 1004. In the transmitting/receiving section 120 (220), implementation may be made in which a transmitting section 120a (220a) and a receiving section 120b (220b) are separated from each other physically or logically.

The input apparatus 1005 is an input device that receives input from the outside (for example, a keyboard, a mouse, a microphone, a switch, a button, a sensor, or the like). The output apparatus 1006 is an output device that performs output to the outside (for example, a display, a speaker, a light emitting diode (LED) lamp, or the like). Note that the input apparatus 1005 and the output apparatus 1006 may be provided in an integrated configuration (for example, a touch panel).

Further, these apparatuses such as the processor 1001 and the memory 1002 are connected to each other by the bus 1007 to communicate information. The bus 1007 may be formed with a single bus, or may be formed with different buses for respective connections between the apparatuses.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by the hardware. For example, the processor 1001 may be implemented by at least one of these pieces of hardware.

(Variations)

Note that terms described in the present disclosure and terms necessary for understanding the present disclosure may be replaced with terms that have the same or similar meanings. For example, a channel, a symbol, and a signal (signal or signaling) may be replaced with each other. Further, the signal may be a message. A reference signal can be abbreviated as an “RS”, and may be referred to as a pilot, a pilot signal, and the like, depending on which standard applies. Further, a component carrier (CC) may be referred to as a cell, a frequency carrier, a carrier frequency, and the like.

A radio frame may include one or a plurality of periods (frames) in the time domain. Each of the one or plurality of periods (frames) constituting the radio frame may be referred to as a subframe. Furthermore, the subframe may include one or a plurality of slots in the time domain. The subframe may be a fixed time length (for example, 1 ms) that is not dependent on numerology.

Here, the numerology may be a communication parameter applied to at least one of transmission or reception of a certain signal or channel. The numerology may indicate at least one of, for example, a subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, and a specific windowing processing performed by the transceiver in the time domain.

A slot may include one or a plurality of symbols in the time domain (orthogonal frequency division multiplexing (OFDM) symbols, single carrier frequency division multiple access (SC-FDMA) symbols, and the like). Further, the slot may be a time unit based on the numerology.

The slot may include a plurality of mini slots. Each mini slot may include one or a plurality of symbols in the time domain. Further, the mini slot may be referred to as a sub-slot. Each mini slot may include fewer symbols than the slot. A PDSCH (or PUSCH) transmitted in a time unit larger than a mini slot may be referred to as a PDSCH (PUSCH) mapping type A. A PDSCH (or PUSCH) transmitted using a mini slot may be referred to as a PDSCH (PUSCH) mapping type B.

The radio frame, subframe, slot, mini slot, and symbol all represent the time unit in signal communication. Other names may be used respectively corresponding to the radio frame, subframe, slot, mini slot, and symbol. Note that time units such as the frame, subframe, slot, mini slot, and symbol in the present disclosure may be replaced with each other.

For example, one subframe may be referred to as a TTI, a plurality of consecutive subframes may be referred to as a TTI, or one slot or one mini slot may be referred to as a TTI. That is, at least one of the subframe or TTI may be a subframe (1 ms) in the existing LTE, may be a period shorter than 1 ms (for example, one to thirteen symbols), or may be a period longer than 1 ms. Note that a unit to represent a TTI may be referred to as a slot, a mini slot, or the like, instead of a subframe.

Here, the TTI refers to the minimum time unit of scheduling in radio communication, for example. For example, in the LTE system, a base station performs scheduling to allocate radio resources (a frequency bandwidth, transmit power, and the like that can be used in each user terminal) to each user terminal in TTI units. Note that a definition of the TTI is not limited thereto.

The TTI may be a transmission time unit of a channel-encoded data packet (transport block), a code block, a codeword, or the like, or may be a processing unit of scheduling, link adaptation, or the like. Note that when the TTI is given, a time interval (for example, the number of symbols) to which the transport block, code block, codeword, or the like is actually mapped may be shorter than the TTI.

Note that in a case where one slot or one mini slot is referred to as a TTI, one or more TTIs (that is, one or more slots or one or more mini slots) may be the minimum time unit of scheduling. Further, the number of slots (the number of mini slots) constituting the minimum time unit of the scheduling may be controlled.

A TTI having a time length of 1 ms may be referred to as a usual TTI (TTI in 3GPP Rel. 8 to 12), a normal TTI, a long TTI, a usual subframe, a normal subframe, a long subframe, a slot, and the like. A TTI shorter than the usual TTI may be referred to as a shortened TTI, a short TTI, a partial TTI (or fractional TTI), a shortened subframe, a short subframe, a mini slot, a sub-slot, a slot, or the like.

Note that the long TTI (for example, the usual TTI, subframe, or the like) may be replaced with a TTI having a time length exceeding 1 ms, and the short TTI (for example, the shortened TTI or the like) may be replaced with a TTI having a TTI length less than the TTI length of the long TTI and not less than 1 ms.

A resource block (RB) is a resource allocation unit in the time domain and the frequency domain, and may include one or a plurality of consecutive subcarriers in the frequency domain. The number of subcarriers included in the RB may be the same regardless of the numerology, and may be twelve, for example. The number of subcarriers included in the RB may be determined on the basis of the numerology.

Further, the RB may include one or a plurality of symbols in the time domain, and may be one slot, one mini slot, one subframe or one TTI in length. One TTI, one subframe, and the like each may include one or a plurality of resource blocks.

Note that one or a plurality of RBs may be referred to as a physical resource block (physical RB (PRB)), a subcarrier group (SCG), a resource element group (REG), a PRB pair, an RB pair, or the like.

Further, the resource block may include one or a plurality of resource elements (REs). For example, one RE may be a radio resource area of one subcarrier and one symbol.

A bandwidth part (BWP) (which may be referred to as a partial bandwidth or the like) may represent a subset of consecutive common resource blocks (RBs) for certain numerology in a certain carrier. Here, the common RB may be specified by the index of the RB based on a common reference point of the carrier. The PRB may be defined in a certain BWP and be numbered within the BWP.

The BWP may include a BWP for UL (UL BWP) and a BWP for DL (DL BWP). For the UE, one or a plurality of BWPs may be configured within one carrier.

At least one of the configured BWPs may be active, and the UE does not have to assume to transmit and receive a given signal/channel outside the active BWP. Note that “cell”, “carrier”, or the like in the present disclosure may be replaced with “BWP”.

Note that structures of the radio frame, subframe, slot, mini slot, symbol, and the like described above are merely examples. For example, configurations such as the number of subframes included in the radio frame, the number of slots per subframe or radio frame, the number of mini slots included in the slot, the number of symbols and RBs included in the slot or mini slot, the number of subcarriers included in the RB, the number of symbols in the TTI, the symbol length, the cyclic prefix (CP) length, and the like can be variously changed.

Further, the information, parameters, and the like described in the present disclosure may be represented by using absolute values, may be represented by using relative values with respect to given values, or may be represented by using other corresponding information. For example, the radio resource may be indicated by a given index.

Names used for the parameters and the like in the present disclosure are not restrictive names in any respect. Furthermore, any mathematical expression or the like that uses these parameters may differ from those explicitly disclosed in the present disclosure. Since various channels (PUCCH, PDCCH, and the like) and information elements can be identified by any suitable names, various names assigned to these various channels and information elements are not restrictive names in any respect.

The information, signals, and the like described in the present disclosure may be represented by using any of a various different technologies. For example, data, an instruction, a command, information, a signal, a bit, a symbol, a chip, and the like that can be referenced throughout the above description may be represented by a voltage, a current, an electromagnetic wave, a magnetic field or a magnetic particle, an optical field or a photon, or any combination of these.

Further, the information, signals, and the like can be output in at least one of a direction from higher layers to lower layers or a direction from lower layers to higher layers. The information, signals, and the like may be input and output via a plurality of network nodes.

The information, signals, and the like that are input and/or output may be stored in a specific location (for example, in a memory), or may be managed with a management table. The information, signals, and the like to be input and/or output can be overwritten, updated, or appended. The information, signals, and the like that are output may be deleted. The information, signals, and the like that are input may be transmitted to other apparatuses.

Notification of information may be performed not only by using the aspects/embodiments described in the present disclosure but also by using another method. For example, notification of information in the present disclosure may be performed by using physical layer signaling (for example, downlink control information (DCI), uplink control information (UCI)), higher layer signaling (for example, radio resource control (RRC) signaling, broadcast information (master information block (MIB), system information block (SIB), or the like), medium access control (MAC) signaling), another signal, or a combination thereof.

Note that physical layer signaling may be referred to as Layer 1/Layer 2 (L1/L2) control information (L1/L2 control signals), L1 control information (L1 control signal), or the like. Further, the RRC signaling may be referred to as an RRC message, and may be, for example, an RRC connection setup message, an RRC connection reconfiguration message, or the like. Further, notification of the MAC signaling may be given by using, for example, a MAC control element (MAC control element (CE)).

Further, notification of given information (for example, notification of information to the effect that “X holds”) is not limited to an explicit notification, and may be made implicitly (for example, by not making the given notification, or by notification of other information).

Judging may be made in values represented by one bit (0 or 1), may be made in Boolean values that represent true or false, or may be made by comparing numerical values (for example, comparison with a given value).

Regardless of being referred to as software, firmware, middleware, a microcode, or a hardware description language, or being referred to as another name, software should be interpreted broadly, to mean an instruction, an instruction set, a code, a code segment, a program code, a program, a subprogram, a software module, an application, a software application, a software package, a routine, a subroutine, an object, an executable file, an execution thread, a procedure, a function, and the like.

Further, the software, instruction, information, and the like may be transmitted and received via a transmission medium. For example, in a case where software is transmitted from a website, a server, or another remote source by using at least one of a wired technology (coaxial cable, optical fiber cable, twisted-pair, digital subscriber line (DSL), or the like) or a radio technology (infrared rays, microwaves, or the like), at least one of the wired technology or the radio technology is included within a definition of the transmission medium.

The terms “system” and “network” used in the present disclosure can be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be interchangeably used.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or a plurality of (for example, three) cells. In a case where the base station accommodates a plurality of cells, an entire coverage area of the base station can be partitioned into a plurality of smaller areas, and each smaller area can provide a communication service through a base station subsystem (for example, an indoor small base station (remote radio head (RRH))). The term “cell” or “sector” refers to a part or the whole of a coverage area of at least one of a base station or a base station subsystem that provide a communication service in this coverage.

In the present disclosure, the terms such as “mobile station (MS)”, “user terminal”, “user equipment (UE)”, and “terminal” can be used interchangeably.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station or the mobile station may be referred to as a transmission apparatus, a reception apparatus, a radio communication apparatus, or the like. Note that at least one of the base station or the mobile station may be a device mounted on a mobile body, the mobile body itself, or the like. The mobile body may be a transportation (for example, a car, an airplane, or the like), may be an unmanned mobile body (for example, a drone, an autonomous car, or the like), or may be a (manned or unmanned) robot. Note that at least one of the base station or the mobile station also includes an apparatus that does not necessarily move during a communication operation. For example, at least one of the base station or the mobile station may be an Internet of Things (IoT) device such as a sensor.

Further, the base station in the present disclosure may be replaced with the user terminal. For example, each aspect/embodiment of the present disclosure may be applied to a configuration in which communication between the base station and the user terminal is replaced with communication between a plurality of user terminals (which may be referred to as, for example, device-to-device (D2D), vehicle-to-everything (V2X), or the like). In this case, the user terminal 20 may have the function of the base station 10 described above. Further, terms such as “uplink” and “downlink” may be replaced with terms corresponding to communication between terminals (for example, “side”). For example, an uplink channel, a downlink channel, and the like may be replaced with a side channel.

Similarly, the user terminal in the present disclosure may be replaced with the base station. In this case, the base station 10 may have the function of the user terminal 20 described above.

In the present disclosure, the operation performed by the base station may be performed by an upper node thereof in some cases. In a network including one or a plurality of network nodes including the base station, it is clear that various operations performed for communication with the terminal can be performed by the base station, one or more network nodes (for example, a mobility management entity (MME), a serving-gateway (S-GW), and the like are conceivable, but not limited thereto) other than the base station, or a combination thereof.

Each aspect/embodiment described in the present disclosure may be used alone, used in combination, or switched in association with execution. Further, the order in a processing procedure, a sequence, a flowchart, and the like of the aspects/embodiments described in the present disclosure may be re-ordered as long as there is no inconsistency. For example, regarding the methods described in the present disclosure, elements of various steps are presented using an illustrative order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), future radio access (FRA), new radio access technology (RAT), new radio (NR), new radio access (NX), future generation radio access (FX), Global System for Mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), or another appropriate radio communication method, a next generation system extended on the basis of these, and the like. Further, a plurality of systems may be combined (for example, a combination of LTE or LTE-A and 5G) and applied.

The phrase “on the basis of” as used in the present disclosure does not mean “on the basis of only”, unless otherwise specified. In other words, the phrase “on the basis of” means both “on the basis of only” and “on the basis of at least”.

Any reference to an element using designations such as “first” and “second” used in the present disclosure does not generally limit the amount or order of these elements. These designations may be used in the present disclosure only for convenience as a method for distinguishing between two or more elements. Thus, reference to the first and second elements does not mean that only two elements are employed, or that the first element must precede the second element in some way.

The term “determining” used in the present disclosure may include a wide variety of operations. For example, “determining” may be regarded as “determining” of judging, calculating, computing, processing, deriving, investigating, looking up, search, inquiry (for example, looking up in a table, database, or another data structure), ascertaining, or the like.

Further, “determining” may be regarded as “determining” of receiving (for example, receiving information), transmitting (for example, transmitting information), inputting, outputting, accessing (for example, accessing data in a memory), and the like.

Further, “determining” may be regarded as “determining” of resolving, selecting, choosing, establishing, comparing, and the like. That is, “determining” may be regarded as “determining” of some operation.

Further, “determining” may be replaced with “assuming”, “expecting”, “considering”, and the like.

The “maximum transmit power” described in the present disclosure may mean a maximum value of transmit power, the nominal UE maximum transmit power, or the rated UE maximum transmit power.

As used in the present disclosure, the terms “connected” and “coupled”, or any variation of these terms mean all direct or indirect connections or couplings between two or more elements, and may include the presence of one or more intermediate elements between two elements that are “connected” or “coupled” to each other. The coupling or connection between the elements may be physical, logical or a combination of these. For example, “connection” may be replaced with “access”.

In the present disclosure, in a case where two elements are connected to each other, it is conceivable that the elements are “connected” or “coupled” to each other by using one or more electrical wires, cables, printed electrical connections, and the like, and, as some non-limiting and non-inclusive examples, by using electromagnetic energy having wavelengths in the radio frequency, microwave, and optical (both visible and invisible) regions, or the like.

In the present disclosure, a term “A and B are different” may mean “A and B are different from each other”. Note that the term may mean that “A and B are different from C”. The terms such as “separated”, “coupled”, and the like may be interpreted as “different”.

In a case where the terms such as “include”, “including”, and variations of these are used in the present disclosure, these terms are intended to be inclusive, similarly to the term “comprising”. Furthermore, the term “or” as used in the present disclosure is intended to be not an exclusive-OR.

In the present disclosure, for example, in a case where translations add articles such as a, an, and the in English, the present disclosure may include that the noun that follows these articles is in the plural.

In the above, the invention according to the present disclosure has been described in detail; however, it is obvious to those skilled in the art that the invention according to the present disclosure is not limited to the embodiments described in the present disclosure. The invention according to the present disclosure can be embodied with various corrections and in various modified aspects, without departing from the spirit and scope of the invention defined on the basis of the description of claims. Thus, the description of the present disclosure is for the purpose of explaining examples and does not bring any limiting meaning to the invention according to the present disclosure.

This application is based on Japanese Patent Application No. 2019-093131 filed on May 16, 2019. All disclosure of the application is herein incorporated.

1. A user terminal comprising:
a control section that determines, in a case where different subcarrier spacings are configured for an uplink and a downlink, on a basis of a hybrid automatic repeat request-acknowledgement (HARQ-ACK) timing value indicated by a number of first time units shorter than a slot for the uplink, a set of one or more candidate opportunities for receiving a downlink shared channel within a given number of the first time units; and
a transmitting section that transmits a codebook determined on a basis of the set of the candidate opportunities.

2. The user terminal according to claim 1, wherein in a case where the subcarrier spacing in the uplink is less than the subcarrier spacing in the downlink, the HARQ-ACK timing value is associated with a plurality of slots for the downlink or a plurality of second time units for the downlink, and each of the plurality of second time units is shorter than one slot for the downlink.

3. The user terminal according to claim 1, wherein in a case where the subcarrier spacing in the uplink is greater than the subcarrier spacing in the downlink, the HARQ-ACK timing value is associated with a single second time unit shorter than one slot for the downlink, and the second time unit is shorter than one slot for the downlink.

4. The user terminal according to claim 1, wherein the control section determines a reference point of the HARQ-ACK timing value on a basis of the time unit for the uplink that overlaps with a last symbol of the downlink shared channel.

5. The user terminal according to claim 1, wherein the control section determines the set on a basis of a format of the time unit.

6. A radio communication method comprising:
determining, in a case where different subcarrier spacings are configured for an uplink and a downlink, on a basis of a hybrid automatic repeat request-acknowledgement (HARQ-ACK) timing value indicated by a number of first time units shorter than a slot for the uplink, a set of one or more candidate opportunities for receiving a downlink shared channel within a given number of the first time units; and
transmitting a codebook determined on a basis of the set of the candidate opportunities.

7. The user terminal according to claim 2, wherein the control section determines a reference point of the HARQ-ACK timing value on a basis of the time unit for the uplink that overlaps with a last symbol of the downlink shared channel.

8. The user terminal according to claim 3, wherein the control section determines a reference point of the HARQ-ACK timing value on a basis of the time unit for the uplink that overlaps with a last symbol of the downlink shared channel.

9. The user terminal according to claim 2, wherein the control section determines the set on a basis of a format of the time unit.

10. The user terminal according to claim 3, wherein the control section determines the set on a basis of a format of the time unit.

11. The user terminal according to claim 4, wherein the control section determines the set on a basis of a format of the time unit.
